(19) United States
(12) Patent Application Publication
(10) Pub. No.: US 2026/0115900 A1
(43) Pub. Date: Apr. 30, 2026

(54) SIMULATION SYSTEM AND SIMULATION METHOD

(71) Applicant: KABUSHIKI KAISHA YASKAWA DENKI, Kitakyushu-shi (JP)

(72) Inventors: Takeshi YAMASHITA, Fukuoka (JP); Yukio HASHIGUCHI, Fukuoka (JP); Yosuke KAMIYA, Fukuoka (JP); Yuki OE, Fukuoka (JP); Yoshifumi ONOYAMA, Fukuoka (JP)

(21) Appl. No.: 19/426,064

(22) Filed: Dec. 19, 2025

Related U.S. Application Data
(63) Continuation of application No. PCT/JP2023/022792, filed on Jun. 20, 2023.

(51) Int. Cl. B25J 9/16

(52) U.S. Cl. CPC B25J 9/1605

(57) ABSTRACT

A simulation system is for simulating a cell having a plurality of types of machines and a plurality of types of controllers that cause the plurality of types of machines to perform operations coordinated with one another. The simulation system includes: circuitry configured to cause, in a simulation environment, a plurality of types of virtual controllers respectively corresponding to the plurality of types of controllers to simulate the coordinated operations; and a plurality of types of user interfaces each of which is configured to access a corresponding virtual controller of the simulation environment for engineering, the plurality of types of user interfaces differing from one another depending on a type of the corresponding virtual controller.

### CROSS-REFERENCE TO RELATED APPLICATIONS

This application is a continuation application of PCT Application No. PCT/JP2023/022792, filed on Jun. 20, 2023. The entire contents of the above listed PCT and priority applications are incorporated herein by reference.

### BACKGROUND

### Field

The present disclosure relates to a simulation system and a simulation method.

### Description of the Related Art

PCT International Publication No. 2021/261018 discloses a simulation device including a first simulator that simulates control of a first machine by a first controller, a second simulator that simulates control of a second machine by a second controller, and a simulation manager that controls the progress of simulation by the first simulator and the progress of simulation by the second simulator so as to correspond to the relationship between the progress of control by the first controller and the progress of control by the second controller.

### SUMMARY

Disclosed herein is a simulation system for simulating a cell having a plurality of types of machines and a plurality of types of controllers that cause the plurality of types of machines to perform operations coordinated with one another. The simulation system may include: circuitry configured to cause, in a simulation environment, a plurality of types of virtual controllers respectively corresponding to the plurality of types of controllers to simulate the coordinated operations; and a plurality of types of user interfaces each of which is configured to access a corresponding virtual controller of the simulation environment for engineering, the plurality of types of user interfaces differing from one another depending on a type of the corresponding virtual controller.

Additionally, a simulation system for simulating a cell having a plurality of types of machines and a plurality of types of controllers that cause the plurality of types of machines to perform operations coordinated with one another is disclosed herein. The simulation system may include: a plurality of types of user interfaces that are configured to respectively access the plurality of types of controllers, the plurality of types of user interfaces differing from one another depending on a type of a corresponding controller and each being specialized for engineering of the corresponding controller; circuitry configured to: cause the plurality of types of machines to perform the coordinated operations in a virtual space based on control results of the plurality of types of machines by the plurality of types of controllers; and cause at least one user interface accessing a corresponding controller to display the virtual space in which the plurality of types of machines perform the coordinated operations.

Additionally, a simulation method for simulating a cell having a plurality of types of machines and a plurality of types of controllers that cause the plurality of types of machines to perform coordinated operations with one another is disclosed herein. The simulation method may include: causing each of a plurality of types of user interfaces to respectively access a plurality of types of virtual controllers included in a simulation environment, the plurality of types of virtual controllers respectively corresponding to the plurality of types of controllers, and the plurality of types of user interfaces differing from one another depending on a type of a corresponding virtual controller; respectively updating a setting of the corresponding virtual controller based on a result of engineering performed by each of the plurality of types of user interfaces; and causing the plurality of types of virtual controllers to simulate the coordinated operations in the simulation environment based on the updated setting of each of the plurality of types of virtual controllers.

### BRIEF DESCRIPTION OF THE DRAWINGS

FIG. 1 is a schematic diagram illustrating an example configuration of a production system.

FIG. 2 is a schematic diagram illustrating an example configuration of a robot.

FIG. 3 is a block diagram illustrating an example functional configuration of a simulation system.

FIG. 4 is a block diagram illustrating a modification of the simulation system.

FIG. 5 is a block diagram illustrating a further modification of the simulation system.

FIG. 6 is a block diagram illustrating a further modification of the simulation system.

FIG. 7 is a block diagram illustrating a further modification of the simulation system.

FIG. 8 is a block diagram illustrating a further modification of the simulation system.

FIG. 9 is a block diagram illustrating a further modification of the simulation system.

FIG. 10 is a block diagram illustrating a further modification of the simulation system.

FIG. 11 is a block diagram illustrating an example hardware configuration of the simulation system.

FIG. 12 is a flowchart illustrating an example pairing procedure.

FIG. 13 is a flowchart illustrating a modification of the pairing procedure.

FIG. 14 is a flowchart illustrating an example setting update procedure.

FIG. 15 is a flowchart illustrating a modification of the setting update procedure.

FIG. 16 is a flowchart illustrating an example message update procedure.

FIG. 17 is a flowchart illustrating an example host simulation procedure.

FIG. 18 is a flowchart illustrating an example local simulation procedure.

FIG. 19 is a flowchart illustrating an example virtual space display procedure.

FIG. 20 is a flowchart illustrating an example export procedure.

FIG. 21 is a flowchart illustrating an example host control procedure.

FIG. 22 is a flowchart illustrating an example local control procedure.

### DETAILED DESCRIPTION

In the following description, with reference to the drawings, the same reference numbers are assigned to the same components or to similar components having the same function, and overlapping description is omitted.

### [Production System]

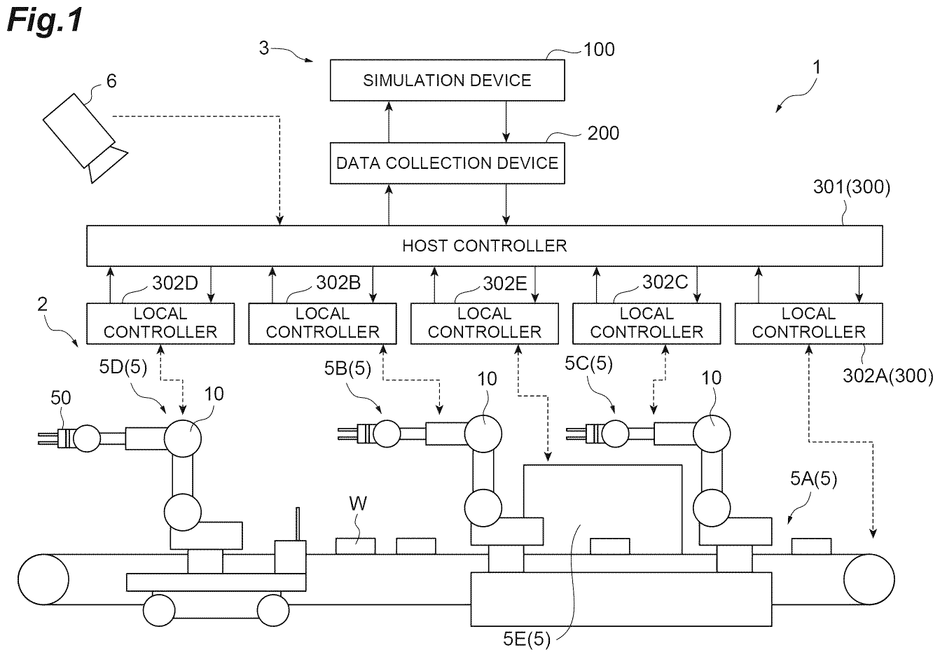

A production system 1 illustrated in FIG. 1 is a system that produces products in a real space. The product may be any tangible object produced by mechanical processing or assembly of one or more parts. The real space is a space where tangible objects actually exist.

The production system 1 includes a cell 2 and a control system 3. The cell 2 produces products by executing processing operations on a workpiece W in the real space. The workpiece W is a tangible object handled by the cell 2 to constitute at least a part of a product. For example, the workpiece W may be a part to be assembled into a product, an intermediate product configured by assembly of parts or the like, or the finally completed product itself.

The processing operations for the workpiece W include a plurality of tasks. A task is a set of operations whose order is predetermined for a predetermined work. At least one of the plurality of tasks can be shared by two or more different types of processing operations. The execution order of the plurality of tasks can be changed depending on the content of the processing operations, but the order of operations within one task cannot be changed. Examples of the plurality of tasks include carrying a base part into a work area, assembling a part to the base part, fixing the part to the base part by fastening, welding, or the like, and carrying out the completed product, which is formed by assembling one or more parts to the base part, from the work area.

For example, the cell 2 includes a plurality of machines 5. The plurality of machines 5 include two or more machines 5 of different types from one another. “Differing in type” means, for example, that platforms for creating control programs are different from each other due to differences in structure or the like. For example, the plurality of machines 5 may include a robot and a machine of a type different from the robot. Examples of the machine of a type different from the robot include a transfer device that transfers the workpiece W, a device that adjusts the position and orientation of the workpiece W to be worked on by the robot, and a machine tool that performs processing on the workpiece W, but are not limited to those listed above. Any machine having any structure is included in the plurality of machines 5 as long as it can execute a task on the workpiece W.

The plurality of tasks may include two or more tasks to be executed sequentially in series, and may include two or more tasks that can be executed concurrently by the plurality of machines 5. Examples of tasks executed by a robot include transfer of the workpiece W, assembly of the workpiece W, fixing of the workpiece W (for example, fastening/welding), and carrying in/out of the workpiece W with respect to peripheral machines such as a machine tool. Examples of tasks executed by a machine tool include opening and closing a door, chucking a carried-in workpiece W, rotating/moving the workpiece W, tool changing, positioning/moving a tool with respect to the workpiece W, and releasing the chuck after processing, and the like.

The plurality of machines 5 illustrated in FIG. 1 include, as two or more machines 5 of different types from one another, a transfer device 5A, robots 5B and 5C, a robot 5D, and a machine tool 5E, but are not limited thereto. The number and types of the machines 5 can be changed in any way as long as at least two or more machines 5 of different types from one another are included.

The transfer device 5A is driven by, for example, an electric motor or the like, and transfers the workpiece W. Examples of the transfer device 5A include a belt conveyor, a roller conveyor, and a carousel.

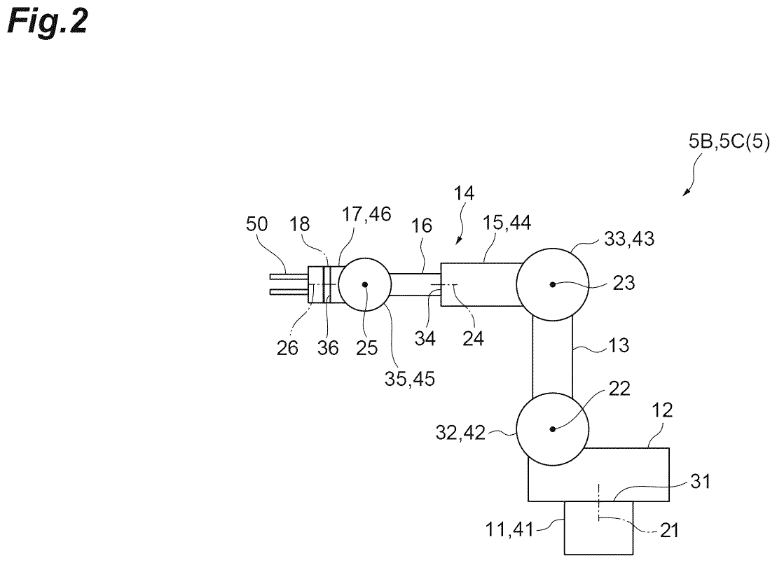

The robots 5B and 5C are vertical articulated robots and, as illustrated in FIG. 2, include an articulated arm 10 and an end effector 50. The end effector 50 acts on the workpiece W. Examples of the end effector 50 include a hand for gripping the workpiece W or the like, a suction nozzle for suctioning the workpiece W, a welding torch for performing welding on the workpiece W, or a screw fastening tool for performing screw fastening on the workpiece W.

The articulated arm 10 is connected to the end effector 50 and changes the position and orientation of the end effector 50 by articulated motion. For example, the articulated arm 10 includes a base 11, a rotation part 12, a first arm 13, a second arm 14, a swing part 15, a third arm 17, a distal end 18, and actuators 41, 42, 43, 44, 45, and 46. The base 11 is installed around the transfer device 5A. The rotation part 12 is provided on the base 11 so as to rotate around a vertical axis 21. The first arm 13 is connected to the rotation part 12 so as to swing around an axis 22 that intersects (for example, is orthogonal to) the axis 21. Intersection also includes cases where the axes are in a skewed relationship, like a so-called grade separation. The second arm 14 is connected to the distal end of the first arm 13 so as to swing around an axis 23 substantially parallel to the axis 22. The second arm 14 includes a swing part 15 and a rotation part 16. The swing part 15 is connected to the distal end of the first arm 13 and extends along an axis 24 that intersects (for example, is orthogonal to) the axis 23. The rotation part 16 is connected to the distal end of the swing part 15 so as to rotate around the axis 24 and extends further along the axis 24. The third arm 17 is connected to the distal end of the rotation part 16 so as to swing around an axis 25 that intersects (for example, is orthogonal to) the axis 24. The distal end 18 is connected to the distal end of the third arm 17 so as to rotate around an axis 26 that intersects (for example, is orthogonal to) the axis 25. A work tool such as a hand, a suction nozzle, or a welding torch is attached to the distal end 18.

Thus, the articulated arm 10 includes a joint 31 connecting the base 11 and the rotation part 12, a joint 32 connecting the rotation part 12 and the first arm 13, a joint 33 connecting the first arm 13 and the second arm 14, a joint 34 connecting the swing part 15 and the rotation part 16 in the second arm 14, a joint 35 connecting the rotation part 16 and the third arm 17, and a joint 36 connecting the third arm 17 and the distal end 18.

The actuators 41, 42, 43, 44, 45, and 46 include, for example, electric motors and reduction gears, and respectively drive the joints 31, 32, 33, 34, 35, and 36. For example, the actuator 41 rotates the rotation part 12 around the axis 21, the actuator 42 swings the first arm 13 around the axis 22, the actuator 43 swings the second arm 14 around the axis 23, the actuator 44 rotates the rotation part 16 around the axis 24, the actuator 45 swings the third arm 17 around the axis 25, and the actuator 46 rotates the distal end 18 around the axis 26.

Note that the configuration of the articulated arm 10 can be modified. For example, the articulated arm 10 may be a 7-axis redundant robot with an additional axis joint added to the 6-axis configuration described above, or may be a so-called SCARA-type articulated robot.

Returning to FIG. 1, the robot 5D is an autonomously mobile robot. For example, the robot 5D is similar to the robots 5B and 5C, but the base 11 of the articulated arm 10 is capable of self-propulsion. An example of the self-propelled base 11 is an electric automated guided vehicle (AGV).

The machine tool 5E performs processing such as cutting on the workpiece W carried in and out by the robots 5B and 5C. Examples of the machine tool 5E include an NC lathe, an NC milling machine, or a machining center. The cell 2 may further include a peripheral device whose movable range overlaps with that of any of the robots 5B, 5C, and 5D. For example, the movable range of the robot 5C (peripheral device) may overlap with that of the robot 5B.

The production system 1 may further include one or more environment sensors 6. Examples of the environment sensor 6 include a presence sensor provided at a position where the workpiece W can be placed, or a camera that captures the position where the workpiece W can be placed. The environment sensor 6 is, for example, a camera or an optical three-dimensional shape sensor, and acquires state information of at least a part of the environment including the plurality of machines 5 and objects surrounding the plurality of machines 5. The environment sensor 6 may be a presence sensor that detects whether the workpiece W is present at a position where the workpiece W can be placed.

The control system 3 controls the plurality of machines 5 to execute production corresponding to a production plan generated by, for example, a manufacturing execution system (MES). For example, the control system 3 includes a plurality of controllers 300, a data collection device 200, and a simulation device 100.

The plurality of controllers 300 cause the plurality of machines 5 to perform operations coordinated with one another. To cause the plurality of machines 5 to perform coordinated operations with one another, each of the plurality of controllers 300 executes its respective processing based on a predetermined control program.

For example, the plurality of controllers 300 include local controllers 302 that respectively control the plurality of machines 5, and a host controller 301. Each of the plurality of local controllers 302 controls a corresponding machine 5 based on a predetermined local control program.

The host controller 301 performs synchronous communication with the plurality of local controllers 302. Synchronous communication means performing communication with the plurality of local controllers 302 for each cycle in synchronization with a synchronous frame of a constant communication cycle. The host controller 301 aggregates information from the plurality of local controllers 302 acquired by the synchronous communication to update environment information, and sequentially assigns tasks to each of the plurality of local controllers 302 based on a predetermined host control program and the environment information. The host controller 301 may also update the environment information based on a detection result from the environment sensor 6.

The local control program of each of the plurality of local controllers 302 includes one or more task programs for causing the machine 5 to execute one or more tasks that can be assigned by the host controller 301. Each of the plurality of local controllers 302 causes the corresponding machine 5 to execute the assigned task by executing a task program corresponding to the task assigned by the host controller 301.

Instead of the host controller 301 assigning tasks to each of the plurality of local controllers 302, each of the plurality of local controllers 302 may select and execute one of the one or more task programs based on a comparison between execution conditions of the one or more task programs and the environment information.

The plurality of controllers 300 may include two or more controllers 300 of different types from one another. Differing in type includes that platforms for creating control programs are different from each other. For example, the host controller 301 and the local controller 302 may be of different types from each other. For example, a platform for creating a local control program and a platform for creating a host control program may be different from each other.

The plurality of local controllers 302 may include two or more local controllers 302 of different types from one another. For example, the plurality of local controllers 302 in FIG. 1 include a local controller 302A that controls the transfer device 5A, local controllers 302B, 302C, and 302D that control the robots 5B, 5C, and 5D, and a local controller 302E that controls the machine tool 5E. The platform for creating the local control program of the local controller 302A, the platform for creating the local control programs of the local controllers 302B, 302C, and 302D, and the platform for creating the local control program of the local controller 302E are different from one another. The platform for creating the local control programs for the local controllers 302B and 302C that control the robots 5B and 5C, and the platform for creating the local control program for the local controller 302D that controls the autonomously mobile robot 5D may be different from each other.

As an example, the platform for creating the local control programs of the local controllers 302B and 302C includes a platform based on a robot programming language. An example of the platform for creating the host control program of the host controller 301 is a platform based on a ladder language.

The data collection device 200 performs network communication with, for example, the host controller 301, and accumulates the environment information updated by the host controller 301 in a database in time series. The simulation device 100 simulates the cell 2. Simulating the cell 2 means operating the cell 2 in a virtual space instead of operating the cell 2 in the real space.

### [Simulation System]

In the production system 1 described above, engineering for the plurality of controllers 300 may be performed to cause the cell 2 to execute desired processing operations. Engineering includes setting of control parameters, creation/editing of control programs, and the like. The engineering for the plurality of controllers 300 is performed by a plurality of types of user interfaces that are respectively accessible to the plurality of controllers 300, differ from one another depending on the type of the corresponding controller 300, and are each specialized for the engineering of the corresponding controller 300. For this reason, engineering can be performed through the collaboration of a plurality of users having different skills (for example, platforms for which they have programming skills).

However, until the cell 2 is made to execute the desired processing operations by the engineering results of individual users entails many trial-and-error iterations at each stage, from the operation verification of individual machines 5 to the operation verification of the entire cell 2. Performing such trial-and-error on actual machines requires a great deal of effort.

Therefore, the simulation device 100 is configured to execute engineering for the plurality of controllers 300 in a virtual space by using the simulation of the cell 2. To perform engineering in the virtual space, one or more user interfaces for engineering are connected to the simulation device 100. Hereinafter, a simulation system including one or more user interfaces for engineering and the simulation device 100 will be described.

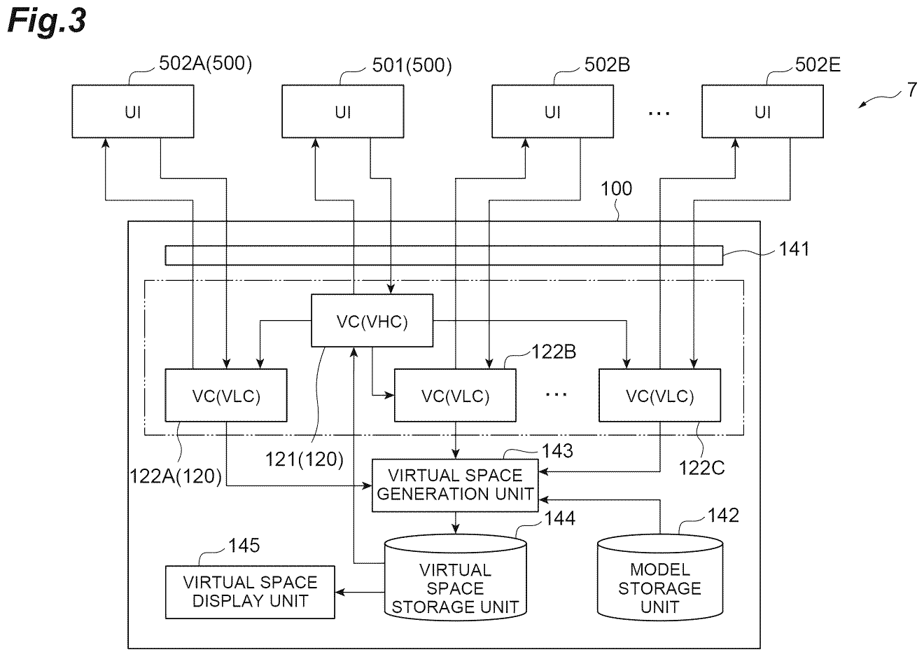

As illustrated in FIG. 3, a simulation system 7 includes a simulation device 100 and a plurality of user interfaces 500. The simulation device 100 includes a simulation environment 101. The simulation environment 101 includes a plurality of virtual controllers 120 respectively corresponding to the plurality of controllers 300, and causes the plurality of virtual controllers 120 to simulate the coordinated operations of the plurality of machines 5. For example, the simulation executed by the plurality of virtual controllers 120 includes estimating, by calculation, phenomena that the plurality of controllers 300 would generate in the real space. The phenomena generated by the plurality of controllers 300 include operating actuators such as the actuators 41, 42, 43, 44, 45, and 46, and performing information communication among the plurality of controllers 300.

Corresponding to the fact that the plurality of controllers 300 include two or more controllers 300 of different types from one another, the plurality of virtual controllers 120 also include two or more virtual controllers 120 of different types from one another. For example, the plurality of virtual controllers 120 include a virtual host controller 121 corresponding to the host controller 301, and a plurality of virtual local controllers 122 respectively corresponding to the plurality of local controllers 302. For example, the plurality of virtual local controllers 122 include a plurality of virtual local controllers 122A to 122E respectively corresponding to the plurality of local controllers 302A to 302E. If the plurality of local controllers 302 include two or more local controllers 302 of different types from one another, the plurality of virtual local controllers 122 also include two or more virtual local controllers 122 of different types from one another. The plurality of user interfaces 500 are respectively accessible to the plurality of virtual controllers 120 of the simulation environment 101. Each of the plurality of user interfaces 500 is configured to access a corresponding virtual controller 120 of the simulation environment 101 for engineering. Each of the plurality of user interfaces 500 is specialized for the engineering of the corresponding virtual controller 120. Two or more user interfaces 500 respectively corresponding to two or more virtual controllers 120 of different types from one another differ from one another depending on the type of the corresponding virtual controller 120.

For example, the plurality of user interfaces 500 include a user interface 501 specialized for the engineering of the virtual host controller 121, and a plurality of user interfaces 502 respectively specialized for the engineering of the plurality of virtual local controllers 122. For example, the plurality of user interfaces 502 include user interfaces 502A to 502E respectively specialized for the engineering of the virtual local controllers 122A to 122E.

With the simulation system 7, similarly to the engineering for the plurality of controllers 300, the engineering for the plurality of virtual controllers 120 can be performed individually by the user interfaces 500 specialized for the engineering of the corresponding virtual controller 120. For this reason, engineering by the collaboration of a plurality of users with different skills can be carried out in the simulation environment, separate from the construction of the hardware of the cell 2. Moreover, in the simulation environment, trial-and-error can be repeated in short cycles from a stage where the completeness of the engineering is low. Therefore, the engineering efficiency for the cell 2 is improved.

Being specialized for the engineering of the corresponding virtual controller 120 includes being unusable for the engineering of a virtual controller 120 of a type different from the corresponding virtual controller 120. Each of the plurality of user interfaces 500 is configured, for example, by executing a user interface program on hardware such as a terminal device. The terminal device may be a general-purpose device such as a laptop computer, a tablet computer, or a smartphone, or may be a terminal device specialized for engineering (for example, a programming pendant for a robot controller).

Two or more user interfaces 500 being different from each other includes, for example, that acceptable user inputs are different from each other, and that displays are different according to the difference in acceptable user inputs. A common terminal device can be used as two or more different user interfaces 500 by means of two or more different user interface programs. The terminal device itself cannot be said to be specialized for the engineering of one type of virtual controller 120, but each of the two or more user interfaces 500, which is configured by the terminal device executing a respective user interface program, is specialized for the engineering of one type of virtual controller 120.

The plurality of user interfaces 500 being respectively accessible to the plurality of virtual controllers 120 includes that at least one user interface 500 is accessible to two or more virtual controllers 120 of different types from one another. If at least one user interface 500 is accessible to two or more virtual controllers 120 of different types from one another, the number of types of user interfaces 500 differs from the number of types of virtual controllers 120.

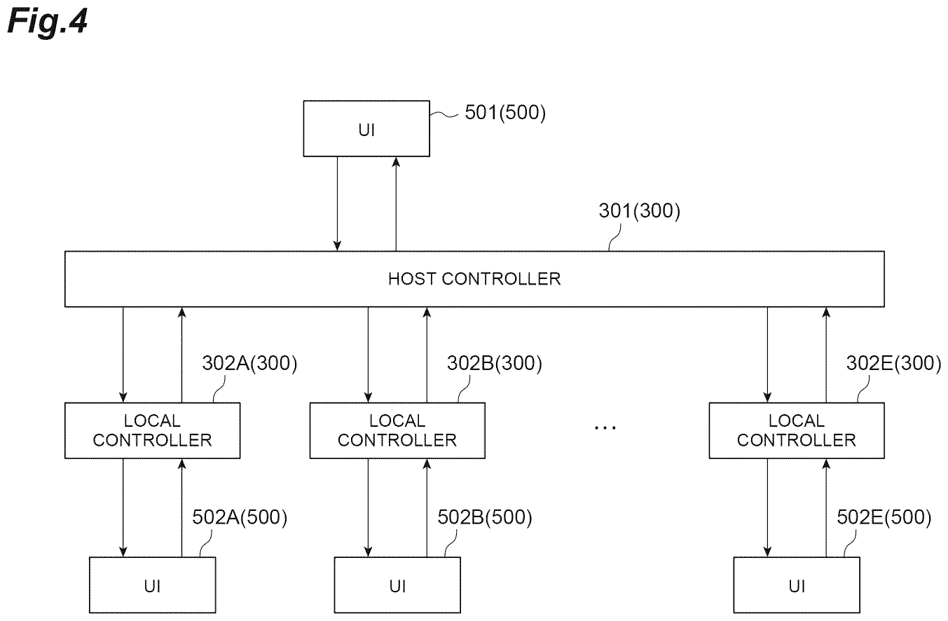

As illustrated in FIG. 4, the plurality of types of user interfaces 500 may be further configured to respectively access the plurality of types of controllers 300. For example, the plurality of user interfaces 500 may be usable for both engineering for the plurality of controllers 300 and engineering for the plurality of virtual controllers 120, but they may not be limited to be usable for both. The same plurality of user interfaces 500 identical to those for engineering for the plurality of controllers 300 may be separately provided for engineering for the plurality of virtual controllers 120. The communication interface between the plurality of user interfaces 500 and the plurality of controllers 300, and the communication interface between the plurality of user interfaces 500 and the plurality of virtual controllers 120 may be common. The communication protocol between the plurality of user interfaces 500 and the plurality of controllers 300, and the communication protocol between the plurality of user interfaces 500 and the plurality of virtual controllers 120 may be common.

By using a common user interface for engineering in a virtual environment and engineering in a real environment (real space), the engineering efficiency in the virtual environment is further improved. For example, in updating the engineering results in the virtual environment with further engineering in the real environment, work can be continued smoothly with a common user interface.

The simulation device 100 may further be configured to: update a setting of the corresponding virtual controller 120 based on a result of engineering performed by each of the plurality of types of user interfaces 500; and cause the plurality of types of virtual controllers to simulate the coordinated operations based on the updated setting of each of the plurality of types of virtual controllers 120.

Returning to FIG. 3, the simulation device 100 may further include an access management unit 141. The access management unit 141 allows the plurality of types of user interfaces 500 to respectively access the plurality of types of virtual controllers 120 independently of one another. For example, in response to one user interface 500 being connected to the simulation device 100, the access management unit 141 identifies the virtual controller 120 corresponding to the one user interface 500 and allows it to access the corresponding virtual controller 120 without allowing it to access other virtual controllers 120. Allowing one user interface 500 to access the corresponding virtual controller 120 includes establishing (for example, pairing) communication between the one user interface 500 and the corresponding virtual controller 120.

The access management unit 141 may assign unique identification information to each of the plurality of virtual controllers 120, and allow one user interface 500 to access the corresponding virtual controller 120 based on the identification information specified by the one user interface 500. The access management unit 141 may assign a unique IP address to each of the plurality of virtual controllers 120 as the identification information, or may assign a combination of a common IP address and a unique port number. Since the access between one user interface 500 and the corresponding virtual controller 120 is independent of the access between other user interfaces 500 and other virtual controllers 120, communication with an intended communication partner can be performed. Even in a system that simulates the entire cell 2, each of the plurality of user interfaces 500 accesses the corresponding virtual controller 120 without accessing other virtual controllers 120. For this reason, each user can concentrate on the engineering of the corresponding virtual controller 120. In addition, since access to each virtual controller 120 is limited to access from the corresponding user interface 500, confusion due to overlapping engineering from two or more user interfaces 500 for one virtual controller 120 is avoided.

The simulation device 100 may include two or more communication ports to which two or more user interfaces 500 can be connected simultaneously. If two or more user interfaces 500 are simultaneously connected to the two or more communication ports, the access management unit 141 may establish two or more communications in parallel, respectively connecting one of the two or more user interfaces 500 and one of the two or more virtual controllers.

The simulation device 100 may further include a model storage unit 142, a virtual space generation unit 143, a virtual space storage unit 144, and a virtual space display unit 145. The model storage unit 142 stores (retains) a system model including models of the plurality of machines 5 and a model of the surrounding environment of the plurality of machines 5. Each of the models of the plurality of machines 5 is data representing the arrangement, structure, shape, size, and the like of the corresponding machine 5 in the real space. The model of the surrounding environment of the plurality of machines 5 is data representing the arrangement, structure, shape, size, and the like in the real space of peripheral objects (for example, structures such as frames and one or more workpieces W) that constitute the surrounding environment of the plurality of machines 5. The arrangement, structure, shape, and size in the system model are represented by, for example, polygon data or voxel data. The coordinate system on which the system model is based corresponds to a virtual space in which the plurality of machines 5 and the surrounding environment of the plurality of machines 5 are virtually arranged.

The virtual space generation unit 143 causes the plurality of machines 5 to perform the coordinated operations in a virtual space based on simulation results by the plurality of types of virtual controllers 120. For example, the virtual space generation unit 143 causes each of the plurality of machines 5 to operate in the virtual space to perform the coordinated operations, based on the operation of the actuators estimated by the simulation executed by the plurality of virtual controllers 120 and the system model stored in the model storage unit 142. For example, the virtual space generation unit 143 operates the models of the robots 5B and 5C in the virtual space by forward kinematics calculation based on the operation angles of the actuators 41, 42, 43, 44, 45, and 46 and the models of the robots 5B and 5C.

The virtual space storage unit 144 stores (retains) the coordinated operations that the virtual space generation unit 143 caused the plurality of machines 5 to perform in the virtual space. For example, the virtual space storage unit 144 stores the temporal change of the state (for example, position, orientation, and the like) of each of the plurality of machines 5 during the execution of the coordinated operations.

The virtual space display unit 145 causes at least one of the plurality of user interfaces 500 to display the virtual space in which the plurality of machines 5 perform the coordinated operations. The movement of the plurality of machines 5 in the virtual space can be checked on each user interface. At this time, since both the machine 5 corresponding to the virtual controller 120 for which engineering was performed and the operations of other machines 5 can be checked, the engineering efficiency is improved.

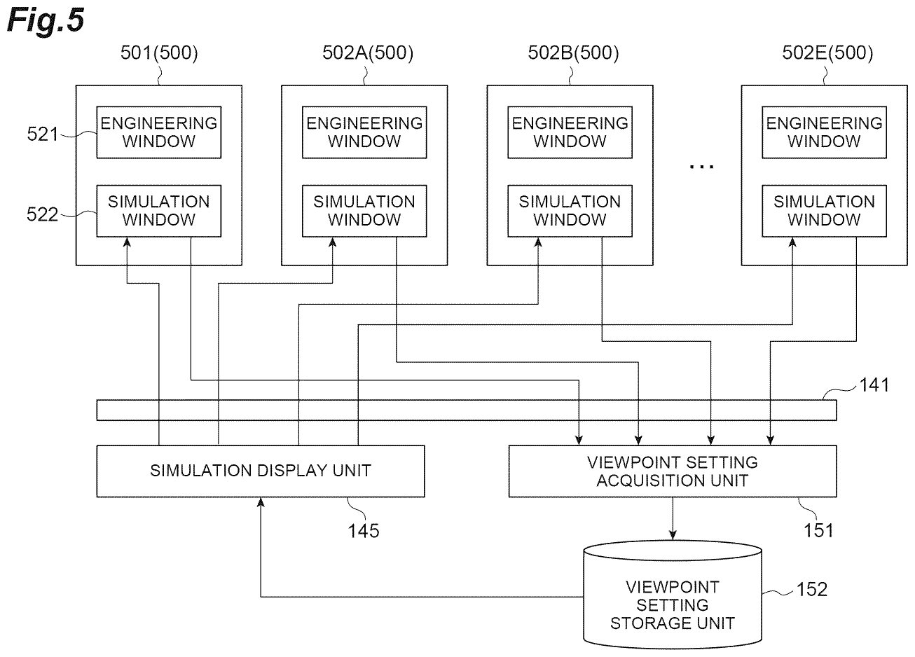

For example, as illustrated in FIG. 5, each of the plurality of user interfaces 500 includes an engineering window 521 and a simulation window 522. The engineering window 521 includes one or more objects (buttons, input boxes, or the like) for receiving user input in the engineering described above. The simulation window 522 displays the virtual space. The virtual space display unit 145 may cause the simulation window 522 of each of the plurality of user interfaces 500 to display the virtual space in which the plurality of machines 5 are performing the coordinated operations.

The virtual space display unit 145 may cause two or more (for example, two or more of different types) of the plurality of user interfaces 500 to display the virtual space from viewpoints independent of one another. By adjusting the viewpoint for each of the plurality of users, the engineering efficiency in the virtual environment is further improved.

The viewpoints independent of one another are, for example, viewpoints set independently of one another by user input. For example, the simulation device 100 may further include a viewpoint setting acquisition unit 151 and a viewpoint setting storage unit 152. A viewpoint includes, for example, a position in the virtual space and a direction from that position.

The viewpoint setting acquisition unit 151 acquires the viewpoint set by the user for each user interface 500 and causes the viewpoint setting storage unit 152 to store (retain) it. For example, the simulation window 522 includes an input object for specifying a viewpoint. The viewpoint setting acquisition unit 151 causes the viewpoint setting storage unit 152 to store (retain) the viewpoint input to the simulation window 522 of each of the plurality of user interfaces 500 in association with the identification information of the user interface 500.

The virtual space display unit 145 acquires the viewpoint of each of the plurality of user interfaces 500 from the viewpoint setting storage unit 152 based on the identification information of the user interface 500, converts the virtual space stored in the virtual space storage unit 144 into a two-dimensional image from the acquired viewpoint, and causes the simulation window 522 of the corresponding user interface 500 to display the two-dimensional image.

The virtual space generation unit 143 may be further configured to cause the plurality of machines 5 to perform the coordinated operations in the virtual space based on control results of the plurality of types of machines 5 by the plurality of types of controllers 300, and the virtual space display unit 145 may be configured to cause at least one user interface 500 accessing a corresponding controller 300 to display the virtual space in which the plurality of types of machines 5 perform the coordinated operations based on the control results of the plurality of machines 5. For example, in response to the virtual space display unit 145 receiving a request from a user interface 500 accessing a controller 300, the virtual space generation unit 143 causes the plurality of machines 5 to perform the coordinated operations in the virtual space based on the control results of the plurality of machines 5 accumulated by the data collection device 200. The virtual space display unit 145 transmits a response to the request (the virtual space in which the plurality of types of machines 5 perform the coordinated operations based on the control results of the plurality of machines 5) to the user interface 500 via the data collection device 200 and the controller 300.

By reproducing the operations of the plurality of machines 5 in the real space in the virtual space, detailed verification of the operations of the plurality of types of machines 5 can be readily performed. For example, with the virtual space that reproduces the operations of the plurality of machines 5 in the real space, the operations of the plurality of machines 5 can be readily verified by arbitrarily changing the viewpoint and the reproduction target time (playback time).

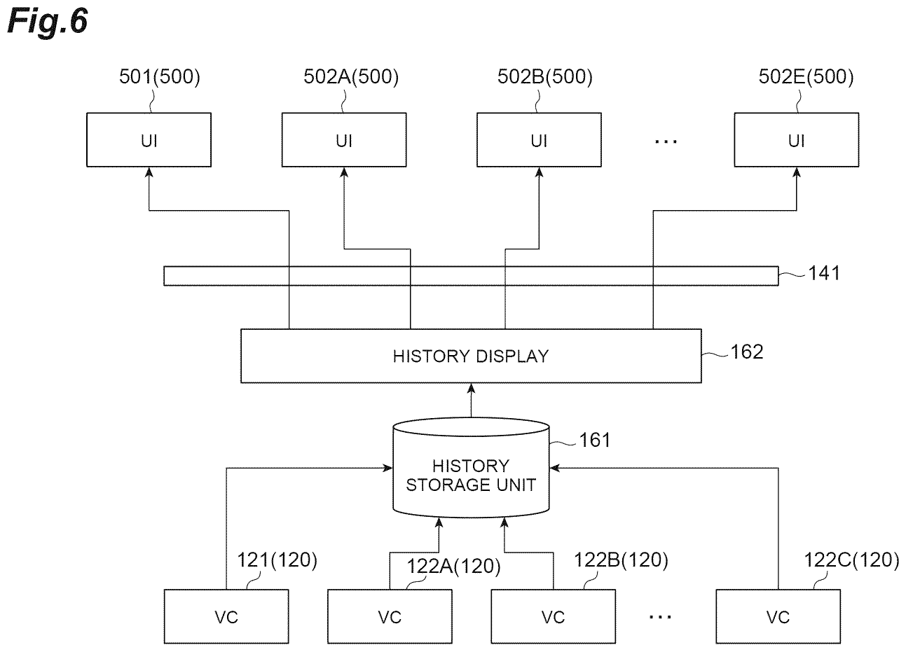

As illustrated in FIG. 6, the simulation device 100 may further include a history storage unit 161. The history storage unit 161 stores a history of engineering by each of the plurality of types of user interfaces 500 for a corresponding virtual controller 120. By referring to the history of engineering, the engineering status of the entire cell can be readily grasped.

For example, the simulation device 100 may further include a history display unit 162. The history display unit 162 causes each of the plurality of types of user interfaces 500 to display a history of engineering for one or more virtual controllers 120 other than the corresponding virtual controller 120, based on the history stored in the history storage unit 161. This allows each user to grasp the engineering status of the entire cell more readily.

The history of engineering includes, for example, an update history of control parameters and control programs. The history storage unit 161 may store the update content and the update date and time in association with each other as the update history.

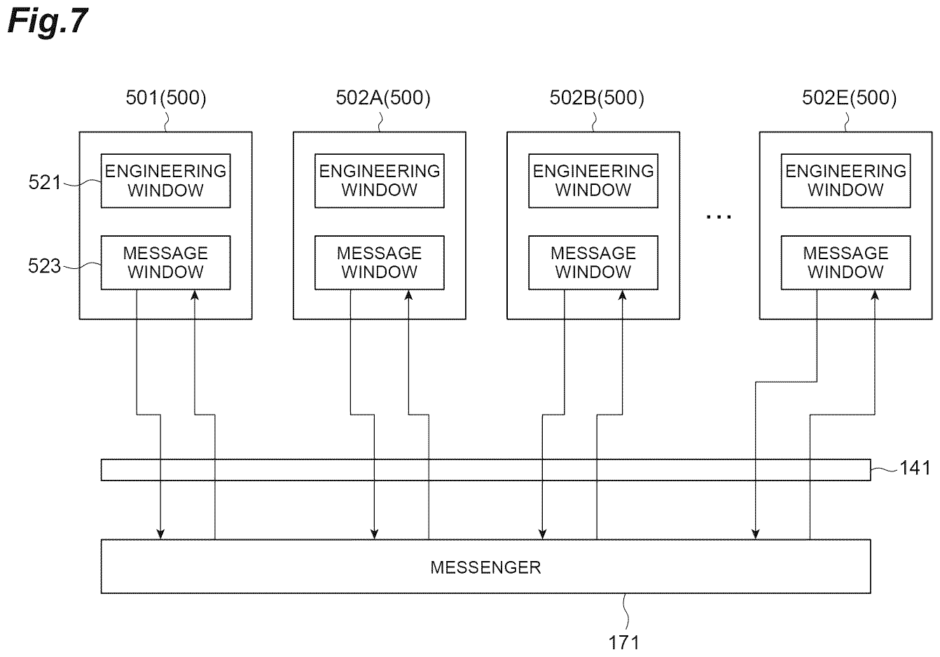

As illustrated in FIG. 7, the simulation device 100 may further include a messenger 171. The messenger 171 displays a message input to one user interface 500 on another user interface 500. For example, each of the plurality of user interfaces 500 further includes a message window 523 where messages can be input and displayed. The messenger 171 accumulates messages input to the message window 523 of each of the plurality of user interfaces 500 in time series, and causes each message window 523 to display the accumulated messages, for example, in a chat format. By facilitating message exchange between users while allowing each user to concentrate on their respective engineering tasks, collaboration among a plurality of users can be promoted, further improving engineering efficiency.

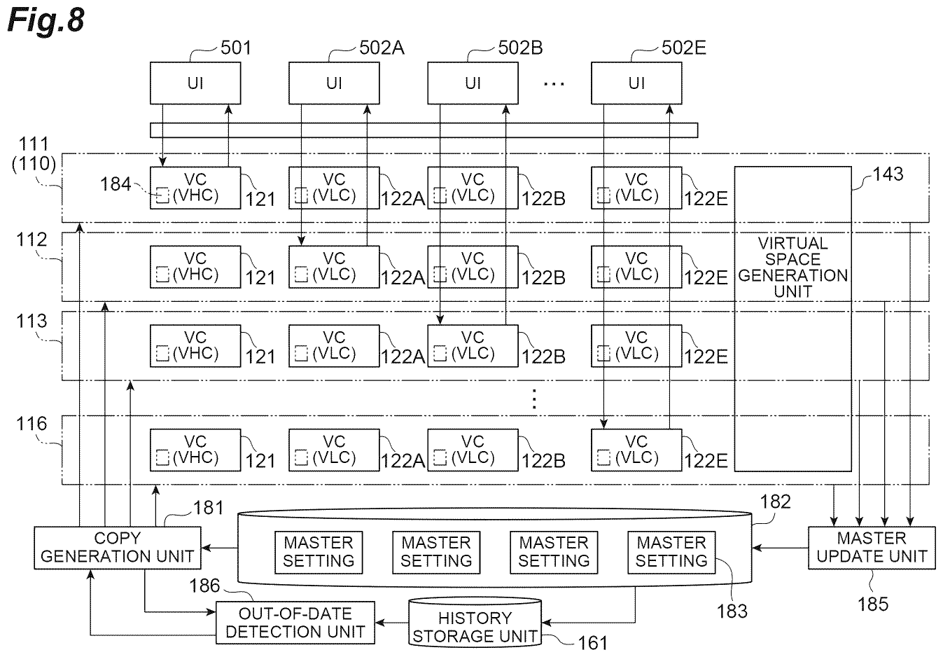

As illustrated in FIG. 8, the simulation device 100 may include a copy generation unit 181 as an example of including the simulation environment 101. The copy generation unit 181 generates, if engineering of a virtual controller 120 corresponding to one user interface 500 of the plurality of types of user interfaces 500 is to be performed, a copy simulation environment 110 corresponding to the one user interface 500 as the simulation environment 101. Thus, including the simulation environment 101 is not limited to constantly having the simulation environment 101, but also includes having the copy generation unit 181 that dynamically generates the copy simulation environment 110.

The copy simulation environment 110 includes a plurality of virtual controllers 120. If the simulation device 100 includes the copy generation unit 181, the access management unit 141 allows the one user interface 500 to access the corresponding virtual controller 120 in the copy simulation environment 110. One user can execute trial-and-error including engineering and cell simulation independently of other users. Therefore, the cell 2 can be constructed more efficiently.

The copy generation unit 181 may generate, if engineering of virtual controllers 120 respectively corresponding to two or more types of user interfaces 500 of the plurality of types of user interfaces 500 is to be performed, two or more copy simulation environments 110 respectively corresponding to the two or more types of user interfaces 500 as the simulation environment 101. The access management unit 141 may allow each of the two or more types of user interfaces 500 to access a corresponding virtual controller 120 in a corresponding copy simulation environment 110. The access management unit 141 does not allow each of the two or more user interfaces 500 to access its corresponding virtual controller 120 in a copy simulation environment 110 other than its own corresponding copy simulation environment 110. Two or more users can execute trial-and-error including engineering and cell simulation independently of each other. Therefore, the cell 2 can be constructed more efficiently.

FIG. 8 illustrates a case where engineering of the virtual controller 120 corresponding to each of the user interface 501 and the user interfaces 502A to 502E is performed. The copy generation unit 181 generates a plurality of copy simulation environments 111 to 116 respectively corresponding to the user interface 501 and the user interfaces 502A to 502E. The access management unit 141 allows the user interface 501 to access the virtual host controller 121 of the copy simulation environment 111, and does not allow it to access the virtual host controllers 121 in the copy simulation environments corresponding to the user interfaces 502A to 502E. Similarly, the access management unit 141 allows the user interface 502A to access the virtual local controller 122A of the copy simulation environment 112, allows the user interface 502B to access the virtual local controller 122B of the copy simulation environment 113, allows the user interface 502C to access the virtual local controller 122C of the copy simulation environment 114, allows the user interface 502D to access the virtual local controller 122D of the copy simulation environment 115, and allows the user interface 502E to access the virtual local controller 122E of the copy simulation environment 116.

The simulation device 100 may further include a master storage unit 182 and a master update unit 185. The master storage unit 182 stores respective master settings 183 of the plurality of virtual controllers 120. The master setting 183 is a setting that defines the control content of the corresponding virtual controller 120. The master setting 183 includes at least one of the control parameters and the control program described above. The master setting 183 may further include identification information (IP address and the like) of the corresponding virtual controller 120.

The copy generation unit 181 may generate, based on the respective master settings 183 of the plurality of virtual controllers 120 stored in the master storage unit 182, a copy simulation environment 110 that causes the plurality of virtual controllers 120, each including a copy setting 184 that is a copy of the master setting 183, to simulate the coordinated operations. The virtual controller 120 accessed by each of the two or more user interfaces 500 may update the copy setting 184 based on a result of engineering performed by a corresponding user interface 500. For example, the virtual host controller 121 of the copy simulation environment 111 updates the copy setting 184 based on the result of engineering performed by the user interface 501, the virtual local controller 122A of the copy simulation environment 112 updates the copy setting 184 based on the result of engineering performed by the user interface 502A, the virtual local controller 122B of the copy simulation environment 113 updates the copy setting 184 based on the result of engineering performed by the user interface 502B, the virtual local controller 122C of the copy simulation environment 114 updates the copy setting 184 based on the result of engineering performed by the user interface 502C, the virtual local controller 122D of the copy simulation environment 115 updates the copy setting 184 based on the result of engineering performed by the user interface 502D, and the virtual local controller 122E of the copy simulation environment 116 updates the copy setting 184 based on the result of engineering performed by the user interface 502E.

The master update unit 185 reflects, in response to a request from each of the two or more types of user interfaces 500, an update result of the copy setting 184 in the corresponding copy simulation environment 110 to the master setting 183. The update result of the copy setting 184 can be reflected to the master setting 183 after increasing the reliability of the copy setting 184 through trial-and-error in the copy simulation environment 110. For this reason, adverse effects of trial-and-error in one copy simulation environment 110 on trial-and-error in other copy simulation environments 110 can be suppressed.

For example, the master update unit 185, in response to a request from the user interface 501, reflects the update result of the copy setting 184 of the virtual host controller 121 in the copy simulation environment 111 to the master setting 183 of the virtual host controller 121; in response to a request from the user interface 502A, reflects the update result of the copy setting 184 of the virtual local controller 122A in the copy simulation environment 112 to the master setting 183 of the virtual local controller 122A; in response to a request from the user interface 502B, reflects the update result of the copy setting 184 of the virtual local controller 122B in the copy simulation environment 113 to the master setting 183 of the virtual local controller 122B; in response to a request from the user interface 502C, reflects the update result of the copy setting 184 of the virtual local controller 122C in the copy simulation environment 114 to the master setting 183 of the virtual local controller 122C; in response to a request from the user interface 502D, reflects the update result of the copy setting 184 of the virtual local controller 122D in the copy simulation environment 115 to the master setting 183 of the virtual local controller 122D; and in response to a request from the user interface 502E, reflects the update result of the copy setting 184 of the virtual local controller 122E in the copy simulation environment 116 to the master setting 183 of the virtual local controller 122E.

The virtual space generation unit 143 may cause, for each of the copy simulation environments 110, the plurality of types of machines 5 to perform the coordinated operations in a virtual space based on simulation results by the plurality of types of virtual controllers 120. The virtual space display unit 145 may cause, for each of the copy simulation environments 110, a corresponding user interface 500 to display the virtual space in which the plurality of types of machines 5 perform the coordinated operations. Each user can check the execution result of their own simulation on their own user interface 500.

The history storage unit 161 may store (retain) an update history of the master setting 183 as the history of engineering for the corresponding virtual controller 120 by each of the plurality of user interfaces 500. The simulation device 100 may further include an out-of-date detection unit 186. The out-of-date detection unit 186 detects, based on respective generation timings of the two or more copy simulation environments 110 and the update history stored in the history storage unit 161, that the copy setting 184 in each of the two or more copy simulation environments 110 is out-of-date. The copy setting 184 being out-of-date means that it is older than the master setting 183.

By making each user aware that the copy setting 184 is out-of-date due to engineering by other users, wasteful simulations can be suppressed, and the engineering efficiency of each user can be further improved.

The copy generation unit 181 may update, based on the master setting 183, the copy setting 184 that is detected to be out-of-date in each of the two or more copy simulation environments 110. Since the copy setting 184 that is detected to be out-of-date is updated by the system, the engineering efficiency of each user is further improved.

The copy generation unit 181 may update the copy setting 184 based on the master setting 183, in response to a request from a user performing engineering in the copy simulation environment 110 where the copy setting 184 is detected to be out-of-date. For example, even if the copy setting 184 is detected to be out-of-date in a copy simulation environment 110, the copy generation unit 181 may wait to update the copy setting 184 based on the master setting 183 until it receives a request from the user performing engineering in the copy simulation environment 110. A decrease in engineering efficiency due to the trial-and-error conditions changing midway can be suppressed.

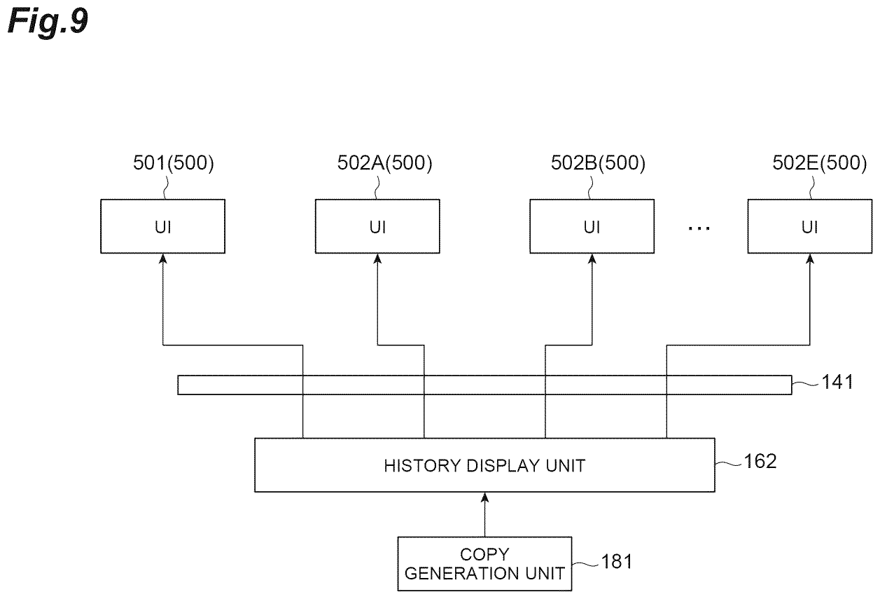

As illustrated in FIG. 9, the history display unit 162 may cause a corresponding user interface 500 to display an updated part in response to the copy setting 184 being updated by the copy generation unit 181 in each of the two or more copy simulation environments 110. Since the influence of the update of the copy setting 184 on the ongoing engineering can be readily grasped, the engineering efficiency of each user is further improved. The display of the updated part is an example of the “history of engineering for a virtual controller 120 other than the corresponding virtual controller 120” described above.

Examples of the display of the updated part include displaying the updated part (for example, line number) in the control program, and displaying an execution time of the updated part in the control program. As another example of displaying the updated part, the history display unit 162 may display a part of the control program being created/edited using the corresponding user interface 500 that may be related to the updated part (for example, a part near the updated part).

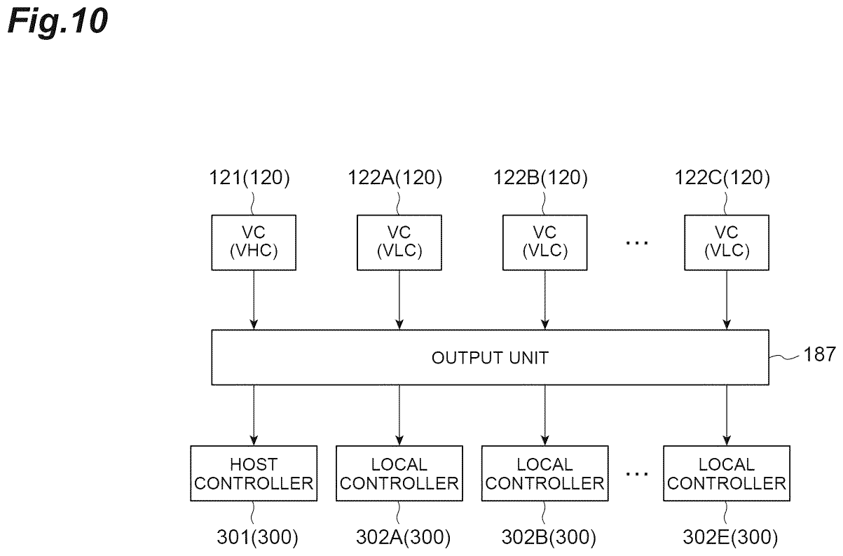

The simulation device 100 may be configured to export the engineering results for the plurality of virtual controllers 120 to the plurality of controllers 300. For example, as illustrated in FIG. 10, the simulation device 100 further includes an output unit 187. The output unit 187 outputs the engineering results for the plurality of virtual controllers 120 from the plurality of virtual controllers 120 to the plurality of controllers 300, respectively. The plurality of controllers 300 cause the plurality of machines 5 to perform coordinated operations in the real space based on the engineering results output from the plurality of virtual controllers 120. For example, the output unit 187 may be configured to output an updated setting (for example, the updated master setting 183) from each of the plurality of virtual controllers 120 to a corresponding controller 300. The plurality of controllers 300 are configured to cause the plurality of machines 5 to perform coordinated operations in the real space based on the updated setting output from each of the plurality of virtual controllers 120 to the corresponding controller 300.

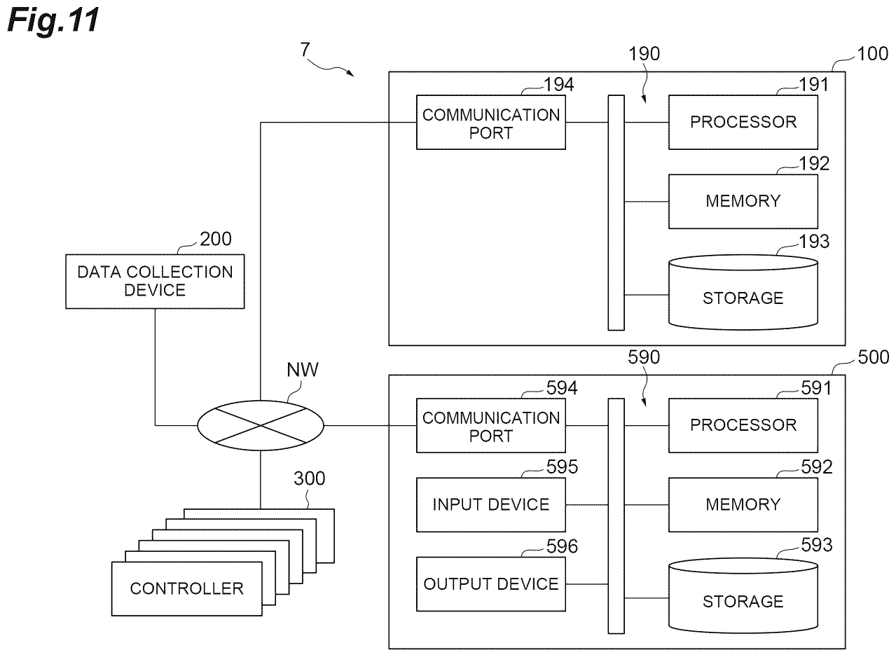

FIG. 11 is a block diagram illustrating a hardware configuration of the simulation system 7. As illustrated in FIG. 11, the simulation device 100 includes circuitry 190. The circuitry 190 includes a processor 191, a memory 192, a storage 193, and a communication port 194. The storage 193 is configured by one or more non-volatile memory devices such as a flash memory or a hard disk. The storage 193 stores a program for causing the simulation device 100 to implement the functional blocks described above.

The memory 192 is configured by one or more volatile memory devices such as a random-access memory. The memory 192 temporarily stores the program loaded from the storage 193. The processor 191 is configured by one or more processing devices such as a CPU or a GPU. The processor 191 executes the program loaded into the memory 192, thereby causing the simulation device 100 to implement the functional blocks described above. The calculation results by the processor 191 are temporarily stored in the memory 192.

The communication port 194 communicates with the data collection device 200, the plurality of controllers 300, and the plurality of user interfaces 500 via a wired or wireless communication network NW in response to a request from the processor 191.

The user interface 500 includes circuitry 590. The circuitry 590 includes a processor 591, a memory 592, a storage 593, a communication port 594, an input device 595, and an output device 596. The storage 593 is configured by one or more non-volatile memory devices such as a flash memory or a hard disk. The storage 593 stores a program for causing the user interface 500 to implement the functional blocks described above.

The memory 592 is configured by one or more volatile memory devices such as a random-access memory. The memory 592 temporarily stores the program loaded from the storage 593. The processor 591 is configured by one or more arithmetic devices such as a CPU or a GPU. The processor 591 executes the program loaded into the memory 592, thereby causing the user interface 500 to implement the functional blocks described above. The calculation results by the processor 591 are temporarily stored in the memory 592.

The communication port 594 communicates with the simulation device 100 via the communication network NW in response to a request from the processor 591. The output device 596 displays information to the user. Examples of the output device 596 include a liquid crystal monitor or an organic EL (Electro-Luminescence) monitor. The input device 595 accepts input of information by the user. Examples of the input device 595 include a keyboard or a mouse. The input device may be integrated with the output device 596 as a touch panel.

### [Simulation Procedure]

Hereinafter, as an example of a simulation method, a simulation procedure executed by the simulation device 100 to enable engineering of the cell 2 in a simulation environment will be illustrated. This simulation procedure includes: in a simulation environment 101, causing a plurality of types of user interfaces 500, which differ from one another depending on a type of a corresponding virtual controller 120 and are each specialized for engineering of the corresponding virtual controller 120, to respectively access a plurality of types of virtual controllers 120; respectively updating the plurality of types of virtual controllers 120 based on inputs to the plurality of types of user interfaces 500; and in the simulation environment 101, causing the updated plurality of types of virtual controllers 120 to simulate the coordinated operations.

The simulation procedure illustrated below includes a pairing procedure for allowing a user interface 500 connected to the simulation device 100 to access a corresponding virtual controller 120, a setting update procedure for updating the virtual controller 120 based on input to the user interface 500, a message update procedure for updating messages between users, a host simulation procedure which is a simulation procedure by the virtual host controller 121, a local simulation procedure which is a simulation procedure by the virtual local controller 122, a display procedure for a virtual space where the plurality of machines 5 perform coordinated operations according to the host simulation procedure and the local simulation procedure, and an export procedure for engineering results. Each procedure will be illustrated.

### (Pairing Procedure)

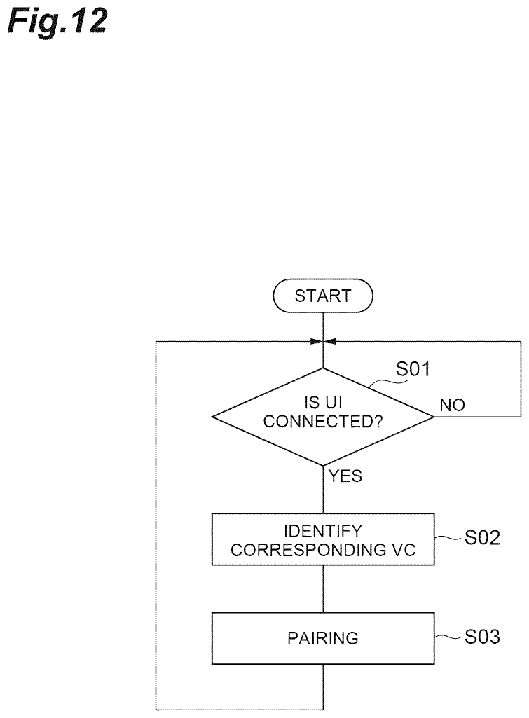

As illustrated in FIG. 12, the simulation device 100 executes operations S01, S02, and S03. In operation S01, the access management unit 141 waits for one user interface 500 to be connected to the simulation device 100. In operation S02, the access management unit 141 identifies the virtual controller 120 corresponding to the one user interface 500 based on the identification information specified by the one user interface 500. In operation S03, the access management unit 141 establishes communication between the one user interface 500 and the corresponding virtual controller 120. Thereafter, the simulation device 100 returns the processing to operation S01. The simulation device 100 repeats the above processing.

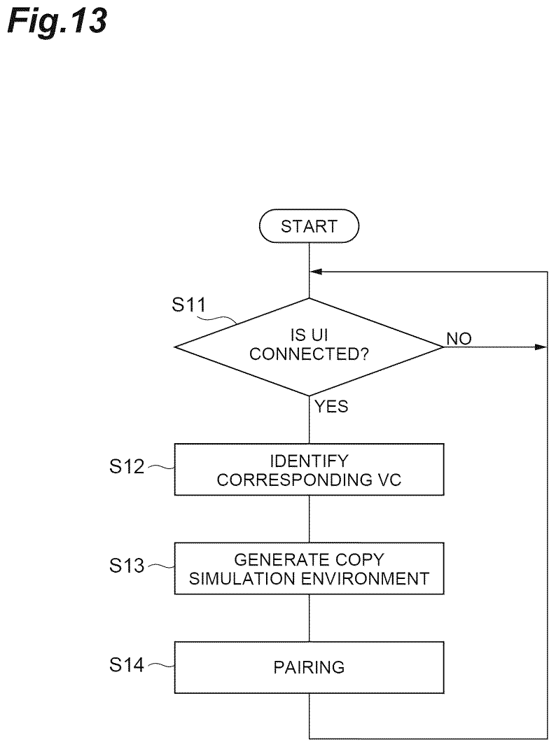

As described above, the simulation device 100 may include the copy generation unit 181. FIG. 13 is a flowchart showing a pairing procedure when the simulation device 100 includes the copy generation unit 181. As illustrated in FIG. 13, the simulation device 100 executes operations S11, S12, S13, and S14. In operation S11, the access management unit 141 waits for one user interface 500 to be connected to the simulation device 100. In operation S12, the access management unit 141 identifies the virtual controller 120 corresponding to the one user interface 500 based on the identification information specified by the one user interface 500.

In operation S13, the copy generation unit 181 generates a copy simulation environment 110 corresponding to the one user interface 500 as the simulation environment 101. For example, the copy generation unit 181 generates the copy simulation environment 110 to be specialized for engineering by the corresponding user interface 500. For example, in the copy simulation environment 110, the copy generation unit 181 does not assign communication identification information to virtual controllers 120 other than the virtual controller 120 corresponding to the user interface 500, and prevents other user interfaces 500 from accessing virtual controllers 120 other than the corresponding virtual controller 120.

In operation S14, the access management unit 141 establishes communication between the one user interface 500 and the corresponding virtual controller 120 in the copy simulation environment 110. Thereafter, the simulation device 100 returns the processing to operation S11. The simulation device 100 repeats the above processing.

### (Setting Update Procedure)

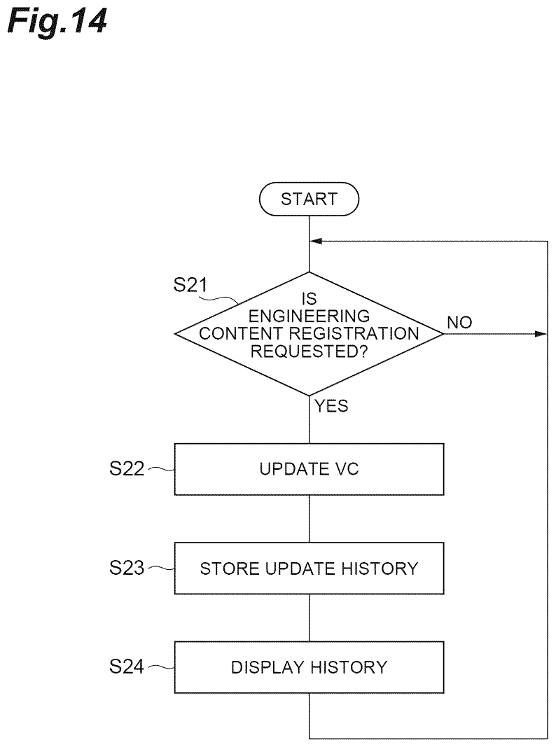

This procedure is a procedure for updating the virtual controller 120 based on input to the user interface 500 that has accessed the corresponding virtual controller 120. As illustrated in FIG. 14, the simulation device 100 executes operations S21, S22, S23, and S24. In operation S21, the virtual controller 120 waits for the user to request registration of engineering content on the user interface 500. In operation S22, the virtual controller 120 updates at least one of the control parameters and the control program of the virtual controller 120 based on the engineering content from the user interface 500. In operation S23, the virtual controller 120 stores the update history of at least one of the control parameters and the control program in the history storage unit 161 as a history of engineering. In operation S24, based on the history stored in the history storage unit 161, the history display unit 162 causes the user interface 500 to display the history of engineering for other virtual controllers 120. Thereafter, the simulation device 100 returns the processing to operation S21. The simulation device 100 repeats the above processing.

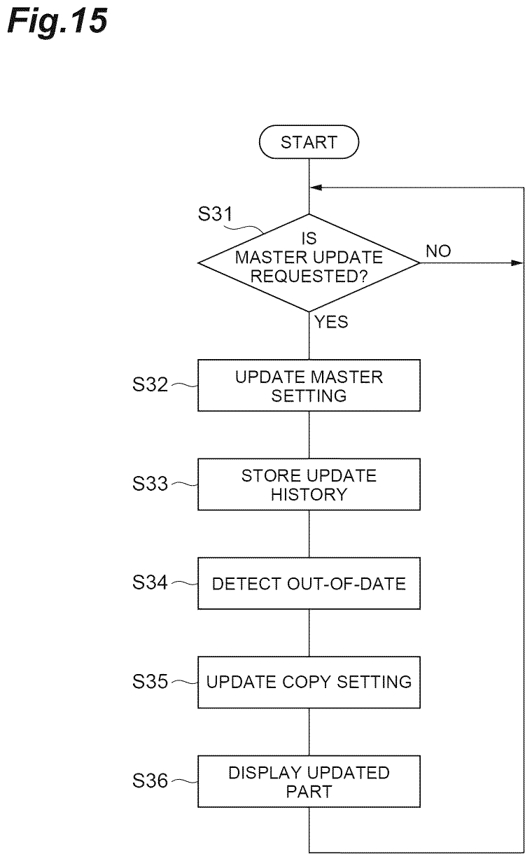

If the simulation device 100 includes the copy generation unit 181, the master storage unit 182, and the master update unit 185, the virtual controller 120 updates the copy setting 184 in the above operation S22. Furthermore, the simulation device 100 also updates the master setting 183. For example, as illustrated in FIG. 15, the simulation device 100 includes operations S31, S32, and S33, and operations S34, S35, and S36. Operations S31, S32, and S33 are executed for one copy simulation environment 110, and operations S34, S35, and S36 are executed for another copy simulation environment 110. In operation S31, the master update unit 185 waits for a request to update the master setting 183 based on the update of the copy setting 184 in one copy simulation environment 110. In operation S32, the master update unit 185 reflects the update result of the copy setting 184 in the one copy simulation environment 110 in the corresponding master setting 183. In operation S33, the master update unit 185 causes the history storage unit 161 to store the update history of the master setting 183 as the history of engineering from the one copy simulation environment 110.

As the master setting 183 is updated, the copy setting 184 corresponding to the updated master setting 183 becomes older than the master setting 183 in the other copy simulation environment 110. In operation S34, the out-of-date detection unit 186 detects, based on the generation timing of the other copy simulation environment 110 and the update history stored in the history storage unit 161, the out-of-dates of the copy setting 184 corresponding to the updated master setting 183 in the other copy simulation environment 110. In operation S35, the copy generation unit 181 updates the copy setting 184 detected to be out-of-date by the out-of-date detection unit 186, based on the updated master setting 183.

In operation S36, in response to the copy setting 184 being updated by the copy generation unit 181, the history display unit 162 causes the user interface 500 corresponding to the other copy simulation environment 110 to display the updated part. Thereafter, the simulation device 100 returns the processing to operation S31. The simulation device 100 repeats the above processing.

### (Message Update Procedure)

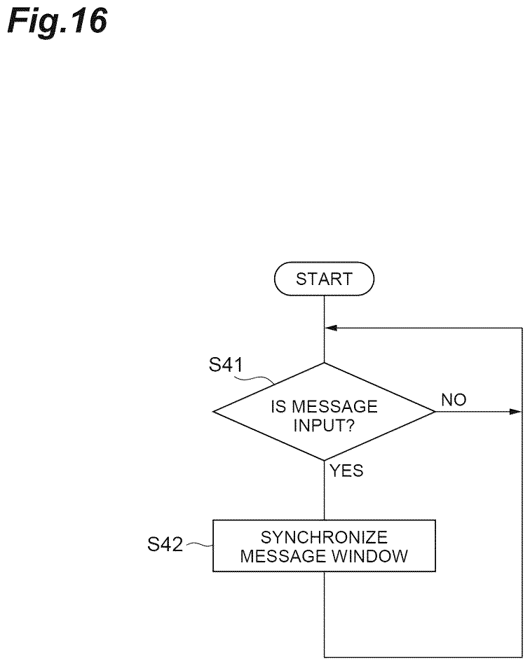

This procedure is executed, for example, in parallel with the procedure of FIG. 14 or FIG. 15. As illustrated in FIG. 16, the simulation device 100 executes operations S41 and S42. In operation S41, the messenger 171 waits for a message to be input to the message window 523 in any of the two or more user interfaces 500 connected to the simulation device 100. In operation S42, the newly input message is added to the messages being accumulated in time series, and the display in the message window 523 of each of the two or more user interfaces 500 is updated to include the added message in the display. Thereafter, the simulation device 100 returns the processing to operation S41. The simulation device 100 repeats the above processing.

### (Host Simulation Procedure)

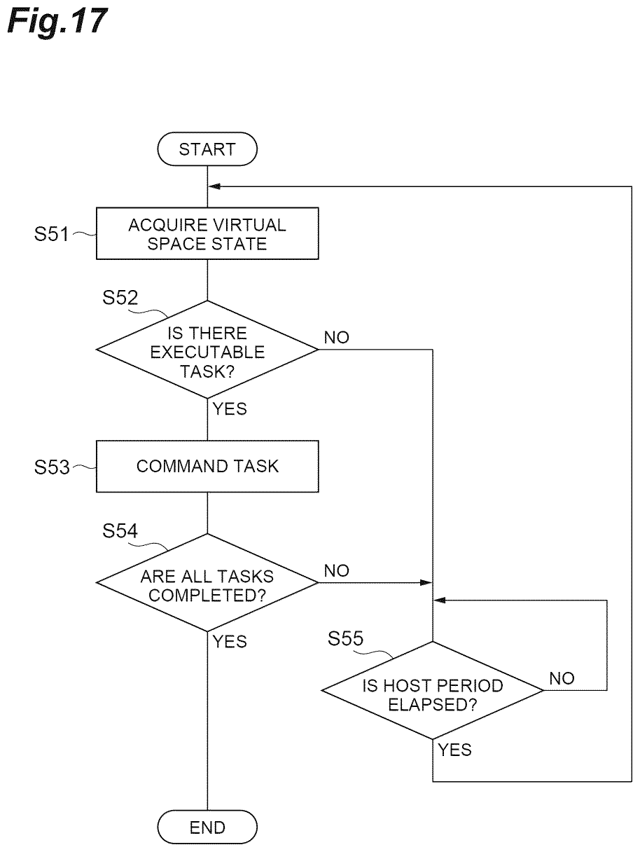

This procedure is a procedure that the simulation device 100 causes the virtual host controller 121 to execute in order to cause the plurality of machines 5 to perform coordinated operations in the virtual space based on the engineering results. As illustrated in FIG. 17, the simulation device 100 executes operations S51 and S52. In operation S51, the virtual host controller 121 acquires the state of the virtual space from the virtual space storage unit 144. In operation S52, the virtual host controller 121 checks whether there is a task that can be executed by any of the plurality of virtual local controllers 122, based on the host control program and the state of the virtual space.

If it is determined in operation S52 that there is a task that can be executed by any of the plurality of virtual local controllers 122, the simulation device 100 executes operations S53 and S54. In operation S53, the virtual host controller 121 commands the virtual local controller 122 that can execute the task to execute the task. In operation S54, the virtual host controller 121 checks whether the execution of all tasks defined in the host control program has been completed.

If it is determined in operation S54 that there is an uncompleted task, the simulation device 100 executes operation S55. If it is determined in operation S52 that there is no task that can be executed by any of the plurality of virtual local controllers 122, the simulation device 100 executes operation S55 without executing operations S53 and S54. In operation S55, the virtual host controller 121 waits for a predetermined host period to elapse, calculated from the start time of operation S51. Thereafter, the simulation device 100 returns the processing to operation S51.

If it is determined in operation S54 that the execution of all tasks has been completed, the simulation device 100 completes the host simulation procedure.

### (Local Simulation Procedure)

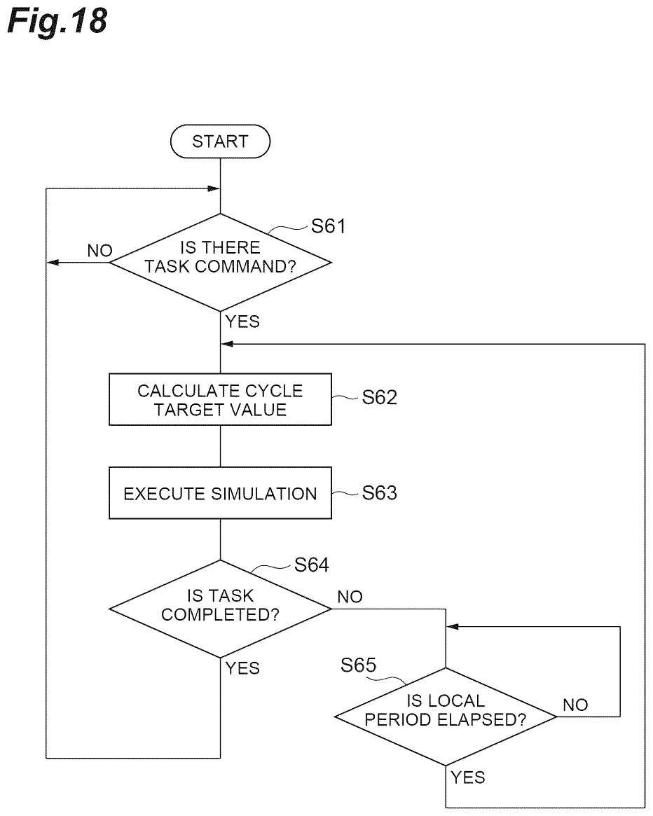

This procedure is a procedure that the simulation device 100 causes the virtual local controller 122 to execute in order to cause the plurality of machines 5 to perform coordinated operations in the virtual space based on the engineering results. As illustrated in FIG. 18, the simulation device 100 executes operations S61, S62, S63, and S64. In operation S61, the virtual local controller 122 waits for a command to execute a task from the virtual host controller 121. In operation S62, the virtual local controller 122 calculates a control target value (cycle target value) for an end of a predetermined local period, based on the task program corresponding to the commanded task.

In operation S63, the virtual local controller 122 calculates the operation angle of the actuator and the like as a simulation result based on the cycle target value. Furthermore, the virtual space generation unit 143 operates the machine 5 corresponding to the virtual local controller 122 in the virtual space based on the simulation result by the virtual local controller 122 and the system model stored in the model storage unit 142. The virtual space generation unit 143 causes the virtual space storage unit 144 to store the result of operating the machine 5 corresponding to the virtual local controller 122 in the virtual space. In operation S64, the virtual local controller 122 checks whether the execution of the task has been completed.

If it is determined in operation S64 that the execution of the task has not been completed, the simulation device 100 executes operation S65. In operation S65, the virtual local controller 122 waits for the local period to elapse, calculated from the start time of operation S62. Thereafter, the simulation device 100 returns the processing to operation S62.

If it is determined in operation S64 that the execution of the task has been completed, the simulation device 100 returns the processing to operation S61 and waits for a command to execute the next task from the virtual host controller 121. The simulation device 100 repeats the above processing. By the simulation device 100 repeatedly causing the plurality of virtual local controllers 122 and the virtual space generation unit 143 to execute the above processing, the plurality of machines 5 perform coordinated operations in the virtual space, and the virtual space where the plurality of machines 5 perform coordinated operations is stored in the virtual space storage unit 144.

### (Virtual Space Display Procedure)

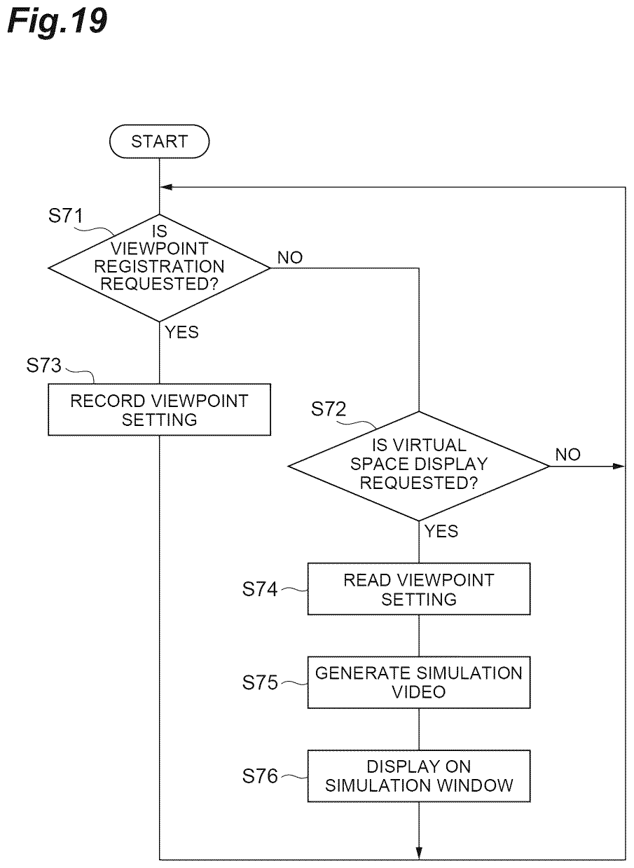

This procedure is a procedure for causing one or more user interfaces 500 to display the virtual space where the plurality of machines 5 perform coordinated operations. As illustrated in FIG. 19, the simulation device 100 executes operation S71. In operation S71, the viewpoint setting acquisition unit 151 checks whether there is a request to register a viewpoint from a user interface 500. If it is determined in operation S71 that there is no request to register a viewpoint, the simulation device 100 executes operation S72.

In operation S72, the virtual space display unit 145 checks whether there is a request to display the virtual space from a user interface 500. If it is determined in operation S72 that there is no request to display the virtual space, the simulation device 100 returns the processing to operation S71.

If it is determined in operation S71 that there is a request to register a viewpoint, the simulation device 100 executes operation S73. In operation S73, the viewpoint setting acquisition unit 151 causes the viewpoint setting storage unit 152 to store the viewpoint acquired from the user interface 500 in association with the identification information of the user interface 500.

If it is determined in operation S72 that there is a request to display the virtual space, the simulation device 100 executes operations S74, S75, and S76. In operation S74, the virtual space display unit 145 reads out the viewpoint associated with the user interface 500 that requested the display of the virtual space from the viewpoint setting storage unit 152. In operation S75, the virtual space display unit 145 converts the virtual space stored in the virtual space storage unit 144 into a two-dimensional image from the acquired viewpoint to generate a simulation video. In operation S76, the virtual space display unit 145 causes the simulation window 522 of the user interface 500 that requested the display of the virtual space to display the generated simulation video.

After executing operations S73 and S76, the simulation device 100 returns the processing to operation S71. The simulation device 100 repeats the above processing.

### (Export Procedure)

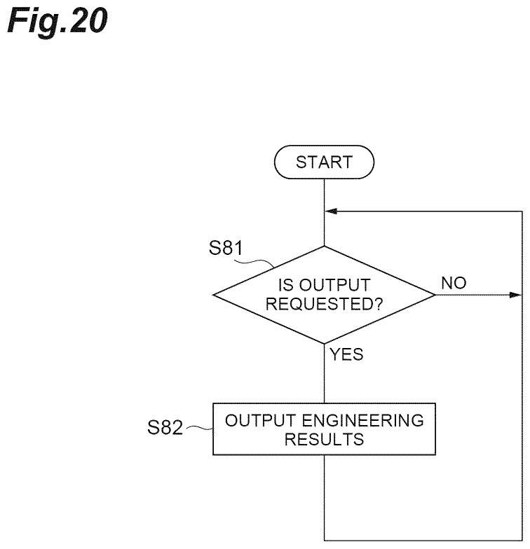

As illustrated in FIG. 20, the simulation device 100 executes operations S81 and S82. In operation S81, the output unit 187 waits for a request to output the engineering results for the plurality of virtual controllers 120, for example, by one of the plurality of user interfaces 500. In operation S82, the output unit 187 outputs the engineering results for the plurality of virtual controllers 120 to the plurality of controllers 300, respectively. Each of the plurality of controllers 300 stores the output engineering results. Thereafter, the simulation device 100 returns the processing to operation S81. The simulation device 100 repeats the above processing.

### [Control Procedure]

Hereinafter, a host control procedure executed by the host controller 301 and a local control procedure executed by the local controller 302 based on the exported engineering results will be illustrated, respectively.

### (Host Control Procedure)

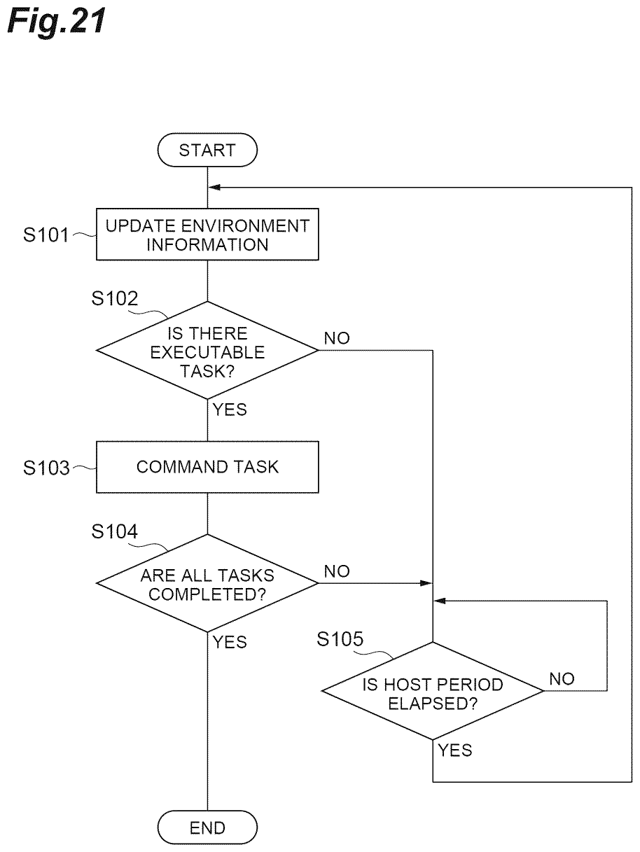

As illustrated in FIG. 21, the host controller 301 executes operations S101 and S102. In operation S101, the host controller 301 updates the environment information of the real space. In operation S102, it checks whether there is a task that can be executed by any of the plurality of local controllers 302, based on the host control program and the environment information.

If it is determined in operation S102 that there is a task that can be executed by any of the plurality of local controllers 302, the host controller 301 executes operations S103 and S104. In operation S103, the host controller 301 commands the local controller 302 that can execute the task to execute the task. In operation S104, the host controller 301 checks whether the execution of all tasks defined by the host control program has been completed.

If it is determined in operation S104 that there is an uncompleted task, the host controller 301 executes operation S105. If it is determined in operation S102 that there is no task that can be executed by any of the plurality of local controllers 302, the host controller 301 executes operation S105 without executing operations S103 and S104. In operation S105, the host controller 301 waits for a predetermined host period to elapse, calculated from the start time of operation S101. Thereafter, the host controller 301 returns the processing to operation S101.

If it is determined in operation S104 that the execution of all tasks has been completed, the host controller 301 completes the host control procedure.

### (Local Control Procedure)

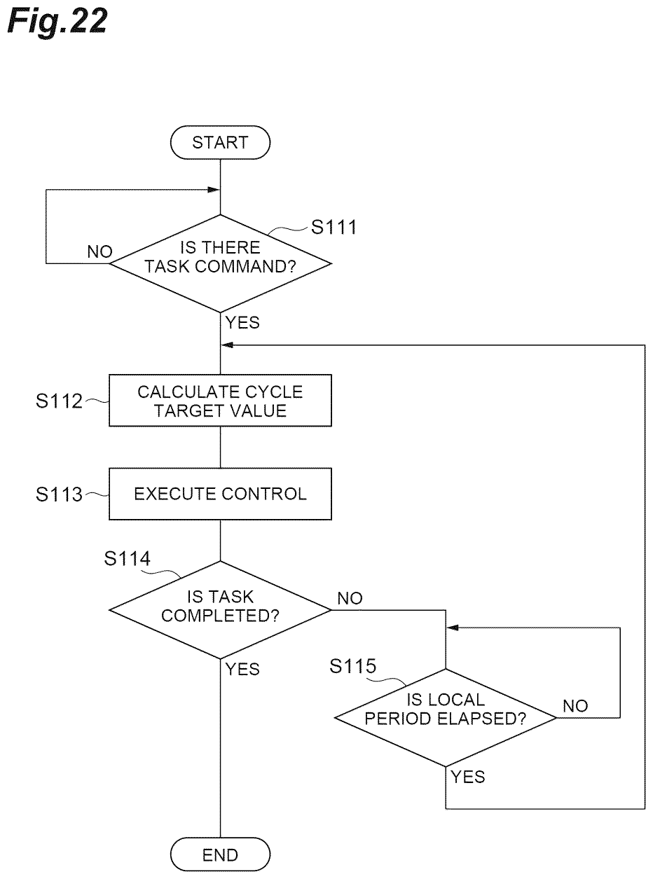

As illustrated in FIG. 22, the local controller 302 executes operations S111, S112, S113, and S114. In operation S111, the local controller 302 waits for a command to execute a task from the host controller 301. In operation S112, the local controller 302 calculates a control target value (cycle target value) for an end of a predetermined local period, based on the task program corresponding to the commanded task.

In operation S113, the local controller 302 controls the actuators of the machine 5 and the like to follow the cycle target value. In operation S114, the local controller 302 checks whether the execution of the task has been completed.

If it is determined in operation S114 that the execution of the task has not been completed, the local controller 302 executes operation S115. In operation S115, the local controller 302 waits for the local period to elapse from the start time of operation S112. Thereafter, the local controller 302 returns the processing to operation S112.

If it is determined in operation S114 that the execution of the task has been completed, the local controller 302 returns the processing to operation S111 and waits for a command to execute the next task from the host controller 301. The local controller 302 repeats the above-described process. By the plurality of local controllers 302 repeating the above-described process, the plurality of machines 5 perform coordinated operations in the real space.

### CONCLUSION

The above disclosure includes the following configurations.

(1) A simulation system 7 for simulating a cell 2 having a plurality of types of machines 5 and a plurality of types of controllers 300 that cause the plurality of types of machines 5 to perform operations coordinated with one another, the simulation system including: a simulation environment 101 configured to cause a plurality of types of virtual controllers 120 respectively corresponding to the plurality of types of controllers 300 to simulate the coordinated operations; and a plurality of types of user interfaces 500 that are configured to respectively access the plurality of types of virtual controllers 120 of the simulation environment 101, the plurality of types of user interfaces 500 differing from one another depending on a type of a corresponding virtual controller 120 and each being specialized for engineering of the corresponding virtual controller 120.

In the cell 2, engineering for each of the plurality of types of controllers 300 can be performed individually by a user interface 500 specialized for the engineering of the corresponding controller 300. For this reason, the cell 2 can be constructed efficiently through the collaboration of a plurality of users with different skills. According to this simulation system 7, similarly to the engineering in the cell 2, engineering for the plurality of types of virtual controllers 120 can be performed individually by the user interfaces 500 specialized for the engineering of the corresponding virtual controller 120. For this reason, engineering by the collaboration of a plurality of users with different skills can be carried out in the simulation environment 101, separate from the construction of the hardware of the cell 2. Therefore, the engineering efficiency for the cell 2 is improved.

(2) The simulation system 7 according to (1), wherein the plurality of types of user interfaces 500 are further configured to respectively access the plurality of types of controllers 300.

By using a common user interface 500 for engineering in a virtual environment and engineering in a real environment, the engineering efficiency in the virtual environment is further improved.

(3) The simulation system 7 according to (1) or (2), further including a history storage unit 161 configured to store a history of engineering by each of the plurality of types of user interfaces 500 for a corresponding virtual controller 120.

By referring to the history of engineering, the engineering status of the entire cell 2 can be readily grasped.

(4) The simulation system 7 according to (3), further including a history display unit 162 configured to cause each of the plurality of types of user interfaces 500 to display a history of engineering for one or more virtual controllers 120 other than the corresponding virtual controller 120, based on the history stored in the history storage unit 161.

This allows each user to grasp the engineering status of the entire cell 2 more readily.

(5) The simulation system 7 according to any one of (1) to (4), further including an access management unit 141 configured to allow the plurality of types of user interfaces 500 to respectively access the plurality of types of virtual controllers 120 independently of one another. The access management unit 141 allows a user interface 500 to access a corresponding virtual controller 120, and this access is independent of access between another user interface 500 and its corresponding virtual controller 120. Therefore, communication with an intended communication partner can be performed, and the user can concentrate on their own engineering without being aware of communication by other user interfaces 500.

(6) The simulation system 7 according to (5), further including a messenger 171 configured to display a message input to one type of user interface 500 on another type of user interface 500.

By facilitating message exchange between users while allowing each user to concentrate on their respective engineering, collaboration among a plurality of users can be promoted, further improving engineering efficiency.

(7) The simulation system 7 according to any one of (1) to (6), further including: a virtual space generation unit 143 configured to cause the plurality of types of machines 5 to perform the coordinated operations in a virtual space based on simulation results by the plurality of types of virtual controllers 120; and a virtual space display unit 145 configured to cause at least one of the plurality of types of user interfaces 500 to display the virtual space in which the plurality of types of machines 5 perform the coordinated operations.

The movement of the plurality of types of machines 5 in the virtual space can be checked on each user interface 500. At this time, since both the machine 5 corresponding to the virtual controller 120 being engineered and the operations of other machines 5 can be checked, the engineering efficiency is improved.

(8) The simulation system 7 according to (7), wherein the virtual space display unit 145 is configured to cause two or more types of the plurality of types of user interfaces 500 to display the virtual space from viewpoints independent of one another.

By adjusting the viewpoint for each of the plurality of users, the engineering efficiency in the virtual environment is further improved.

(9) The simulation system 7 according to (7) or (8), wherein the plurality of types of user interfaces 500 are configured to respectively access the plurality of types of controllers 300, wherein the virtual space generation unit 143 is further configured to cause the plurality of types of machines 5 to perform the coordinated operations in the virtual space based on control results of the plurality of types of machines 5 by the plurality of types of controllers 300, and wherein the virtual space display unit 145 is configured to cause at least one type of user interface 500 accessing a corresponding controller 300 to display the virtual space in which the plurality of types of machines 5 perform the coordinated operations based on the control results.

By reproducing the operations of the plurality of types of machines 5 in the real space in the virtual space, detailed verification of the operations of the plurality of types of machines 5 can be readily performed.

(10) The simulation system 7 according to any one of (1) to (9), further including: a copy generation unit 181 configured to generate, if engineering of a virtual controller 120 corresponding to one type of user interface 500 of the plurality of types of user interfaces 500 is to be performed, a copy simulation environment 110 corresponding to the one type of user interface 500 as the simulation environment 101; and an access management unit 141 configured to allow the one type of user interface 500 to access the corresponding virtual controller 120 in the copy simulation environment 110.

One user can execute trial-and-error including engineering and simulation of the cell 2 independently of other users. Therefore, the cell 2 can be constructed more efficiently.

(11) The simulation system 7 according to (10), wherein the copy generation unit 181 is configured to generate, if engineering of virtual controllers 120 respectively corresponding to two or more types of user interfaces 500 of the plurality of types of user interfaces 500 is to be performed, two or more copy simulation environments 110 respectively corresponding to the two or more types of user interfaces 500 as the simulation environment 101, and wherein the access management unit 141 is configured to allow each of the two or more types of user interfaces 500 to access a corresponding virtual controller 120 in a corresponding copy simulation environment 110.

Two or more users can execute trial-and-error including engineering and simulation of the cell 2 independently of each other. Therefore, the cell 2 can be constructed more efficiently.

(12) The simulation system 7 according to (11), wherein the copy generation unit 181 is configured to generate, based on respective master settings 183 of the plurality of types of virtual controllers 120, a copy simulation environment 110 that causes the plurality of types of virtual controllers 120 to simulate the coordinated operations, wherein each of the plurality of types of virtual controllers 120 within the copy simulation environment has a copy setting 184 created from a corresponding one of the master settings, wherein the virtual controller 120 accessed by each of the two or more types of user interfaces 500 is configured to update the copy setting 184 based on a result of engineering performed by a corresponding user interface 500, and the simulation system 7 further includes a master update unit 185 configured to reflect, in response to a request from each of the two or more types of user interfaces 500, an update result of the copy setting 184 in the corresponding copy simulation environment 110 to the master setting 183.

Adverse effects of trial-and-error in one copy simulation environment 110 on trial-and-error in other copy simulation environments 110 can be suppressed.

(13) The simulation system 7 according to (11) or (12), further including: a virtual space generation unit 143 configured to cause, for each of the copy simulation environments 110, the plurality of types of machines 5 to perform the coordinated operations in a virtual space based on simulation results by the plurality of types of virtual controllers 120; and a virtual space display unit 145 configured to cause, for each of the copy simulation environments 110, a corresponding user interface 500 to display the virtual space in which the plurality of types of machines 5 perform the coordinated operations.

Each user can check the execution result of their own simulation on their own user interface 500.

(14) The simulation system 7 according to (12) or (13), further including: a history storage unit 161 that stores an update history of the master setting 183; and an out-of-date detection unit 186 configured to detect, based on respective generation timings of the two or more copy simulation environments 110 and the update history, that the copy setting 184 in each of the two or more copy simulation environments 110 is out-of-date.

By making each user aware that the copy setting 184 is out-of-date due to engineering by other users, wasteful simulations can be suppressed, and the engineering efficiency of each user can be further improved.

(15) The simulation system 7 according to (14), wherein the copy generation unit 181 is configured to update, based on the master setting 183, the copy setting 184 that is detected to be out-of-date in each of the two or more copy simulation environments 110.

Since the copy setting 184 that is detected to be out-of-date is updated by the system, the engineering efficiency of each user is further improved.

(16) The simulation system 7 according to (15), further including a history display unit 162 configured to cause a corresponding user interface 500 to display an updated part in response to the copy setting 184 being updated by the copy generation unit 181 in each of the two or more copy simulation environments 110.

Since the influence of the update of the copy setting 184 on the ongoing engineering can be readily grasped, the engineering efficiency of each user is further improved.

(17) A simulation system 7 for simulating a cell 2 having a plurality of types of machines 5 and a plurality of types of controllers 300 that cause the plurality of types of machines 5 to perform operations coordinated with one another, the simulation system including: a plurality of types of user interfaces 500 that are configured to respectively access the plurality of types of controllers 300, the plurality of types of user interfaces 500 differing from one another depending on a type of a corresponding controller 300 and each being specialized for engineering of the corresponding controller 300; a virtual space generation unit 143 configured to further cause the plurality of types of machines 5 to perform the coordinated operations in a virtual space based on control results of the plurality of types of machines 5 by the plurality of types of controllers 300; and a virtual space display unit 145 configured to cause at least one user interface 500 accessing a corresponding controller 300 to display the virtual space in which the plurality of types of machines 5 perform the coordinated operations based on the control results.

(18) A simulation method for simulating a cell 2 having a plurality of types of machines 5 and a plurality of types of controllers 300 that cause the plurality of types of machines 5 to perform coordinated operations with one another, the simulation method including: causing a plurality of types of user interfaces to respectively access a plurality of types of virtual controllers included in a simulation environment 101, the plurality of types of virtual controllers 120 respectively corresponding to the plurality of types of controllers 300, and the plurality of types of user interfaces 500 differing from one another depending on a type of a corresponding virtual controller 120 and each being specialized for engineering of the corresponding virtual controller 120; respectively updating the plurality of types of virtual controllers 120 based on inputs to the plurality of types of user interfaces 500; and causing the updated plurality of types of virtual controllers 120 to simulate the coordinated operations in the simulation environment 101.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A simulation system for simulating a cell having a plurality of types of machines and a plurality of types of controllers that cause the plurality of types of machines to perform operations coordinated with one another, the simulation system comprising:
circuitry configured to cause, in a simulation environment, a plurality of types of virtual controllers respectively corresponding to the plurality of types of controllers to simulate the coordinated operations; and
a plurality of types of user interfaces each of which is configured to access a corresponding virtual controller of the simulation environment for engineering, the plurality of types of user interfaces differing from one another depending on a type of the corresponding virtual controller.

2. The simulation system according to claim 1, wherein the circuitry is further configured to:
update a setting of the corresponding virtual controller based on a result of engineering performed by each of the plurality of types of user interfaces; and
cause the plurality of types of virtual controllers to simulate the coordinated operations in the simulation environment based on the updated setting of each of the plurality of types of virtual controllers.

3. The simulation system according to claim 2, wherein the circuitry is further configured to output the updated setting from each of the plurality of types of virtual controllers to a corresponding controller of the cell, and
wherein the plurality of types of controllers are configured to cause the plurality of types of machines to perform the coordinated operations based on the updated setting output from each of the plurality of types of virtual controllers to the corresponding controller.

4. The simulation system according to claim 1, wherein each of the plurality of types of user interfaces is further configured to access a corresponding controller of the cell for engineering.

5. The simulation system according to claim 1, wherein the circuitry is further configured to store, on a history storage, a history of engineering by each of the plurality of types of user interfaces for the corresponding virtual controller.

6. The simulation system according to claim 5, wherein the circuitry is further configured to cause each of the plurality of types of user interfaces to display a history of engineering for one or more virtual controllers other than the corresponding virtual controller, based on the history stored in the history storage.

7. The simulation system according to claim 1, wherein the circuitry is further configured to allow the plurality of types of user interfaces to respectively access the plurality of types of virtual controllers independently of one another.

8. The simulation system according to claim 7, wherein the circuitry is further configured to display a message input to one type of user interface on another type of user interface.

9. The simulation system according to claim 1, wherein the circuitry is further configured to:
cause the plurality of types of machines to perform the coordinated operations in a virtual space based on simulation results by the plurality of types of virtual controllers; and
cause at least one of the plurality of types of user interfaces to display the virtual space in which the plurality of types of machines perform the coordinated operations.

10. The simulation system according to claim 9, wherein the circuitry is configured to cause two or more types of the plurality of types of user interfaces to display the virtual space from viewpoints independent of one another.

11. The simulation system according to claim 9, wherein the plurality of types of user interfaces are configured to respectively access the plurality of types of controllers,
wherein the circuitry is further configured to:
cause the plurality of types of machines to perform the coordinated operations in the virtual space based on control results of the plurality of types of machines by a plurality of types of controllers; and
cause at least one type of user interface accessing a corresponding controller to display the virtual space in which the plurality of types of machines perform the coordinated operations based on the control results.

12. The simulation system according to claim 1, wherein the circuitry is further configured to:
generate, if engineering of a virtual controller corresponding to one type of user interface of the plurality of types of user interfaces is to be performed, a copy simulation environment corresponding to the one type of user interface as the simulation environment; and
allow the one type of user interface to access the corresponding virtual controller in the copy simulation environment.

13. The simulation system according to claim 12, wherein the circuitry is configured to:
generate, if engineering of virtual controllers respectively corresponding to two or more types of user interfaces of the plurality of types of user interfaces is to be performed, two or more copy simulation environments respectively corresponding to the two or more types of user interfaces as the simulation environment; and
allow each of the two or more types of user interfaces to access a corresponding virtual controller in a corresponding copy simulation environment.

14. The simulation system according to claim 13, wherein the circuitry is configured to:
generate, based on respective master settings of the plurality of types of virtual controllers, a copy simulation environment to cause the plurality of types of virtual controllers to simulate the coordinated operations, wherein each of the plurality of types of virtual controllers within the copy simulation environment has a copy setting created from a corresponding one of the master settings;
update the copy setting of the virtual controller accessed by a corresponding user interface based on a result of engineering performed by the corresponding user interface; and
reflect, in response to a request from the corresponding user interfaces, an update result of the copy setting in the corresponding copy simulation environment to the master setting.

15. The simulation system according to claim 13, wherein the circuitry is further configured to:
cause, for each of the copy simulation environments, the plurality of types of machines to perform the coordinated operations in a virtual space based on simulation results by the plurality of types of virtual controllers; and
cause, for each of the copy simulation environments, a corresponding user interface to display the virtual space in which the plurality of types of machines perform the coordinated operations.

16. The simulation system according to claim 14, wherein the circuitry is further configured to:
store, on a history storage, an update history of the master setting; and
detect, based on respective generation timings of the two or more copy simulation environments and the update history, that the copy setting in each of the two or more copy simulation environments is out-of-date.

17. The simulation system according to claim 16, wherein the circuitry is configured to update, based on the master setting, the copy setting that is detected to be out-of-date in each of the two or more copy simulation environments.

18. The simulation system according to claim 17, wherein the circuitry is further configured to cause a corresponding user interface to display an updated part in response to the copy setting being updated in each of the two or more copy simulation environments.

19. A simulation system for simulating a cell having a plurality of types of machines and a plurality of types of controllers that cause the plurality of types of machines to perform operations coordinated with one another, the simulation system comprising:
a plurality of types of user interfaces that are configured to respectively access the plurality of types of controllers, the plurality of types of user interfaces differing from one another depending on a type of a corresponding controller and each being specialized for engineering of the corresponding controller;
circuitry configured to:
cause the plurality of types of machines to perform the coordinated operations in a virtual space based on control results of the plurality of types of machines by the plurality of types of controllers; and
cause at least one user interface accessing a corresponding controller to display the virtual space in which the plurality of types of machines perform the coordinated operations.

20. A simulation method for simulating a cell having a plurality of types of machines and a plurality of types of controllers that cause the plurality of types of machines to perform coordinated operations with one another, the simulation method comprising:
causing each of a plurality of types of user interfaces to respectively access a plurality of types of virtual controllers included in a simulation environment, the plurality of types of virtual controllers respectively corresponding to the plurality of types of controllers, and the plurality of types of user interfaces differing from one another depending on a type of a corresponding virtual controller;
respectively updating a setting of the corresponding virtual controller based on a result of engineering performed by each of the plurality of types of user interfaces; and
causing the plurality of types of virtual controllers to simulate the coordinated operations in the simulation environment based on the updated setting of each of the plurality of types of virtual controllers.
